(19) United States
(12) Patent Application Publication
(10) Pub. No.: US 2026/0370289 A1
(43) Pub. Date: Nov. 19, 2026

(54) CSI REPORTING

(71) Applicant: Samsung Electronics Co., Ltd., Suwon-si (KR)

(72) Inventors: Dalin Zhu, Allen, TX (US); Eko Onggosanusi, Coppell, TX (US)

(21) Appl. No.: 19/639,890

(22) Filed: Apr. 6, 2026

Related U.S. Application Data
(60) Provisional application No. 63/805,134, filed on May 13, 2025.
(60) Provisional application No. 63/891,841, filed on Oct. 1, 2025.
(60) Provisional application No. 63/919,054, filed on Nov. 17, 2025.

(51) Int. Cl. H04B 7/06; H04B 17/309

(52) U.S. Cl. CPC H04B 7/0626; H04B 17/309

(57) ABSTRACT

Apparatuses and methods for channel state information (CSI) reporting. A method performed by a user equipment includes receiving information for a candidate cell, identifying whether the information includes a CSI report configuration for CSI acquisition, and identifying, when the information includes the CSI report configuration, one or more resource settings for CSI acquisition associated with the CSI report configuration. The method further includes identifying, based on the one or more resource settings, channel and interference measurement resources related to CSI acquisition for the candidate cell, determining a CSI report for the candidate cell based on the identified channel and interference measurement resources, and transmitting the CSI report.

### CROSS-REFERENCE TO RELATED AND CLAIM OF PRIORITY

The present application claims priority under 35 U.S.C. § 119(e) to U.S. Provisional Patent Application No. 63/805,134 filed on May 13, 2025; U.S. Provisional Patent Application No. 63/891,841 filed on Oct. 1, 2025; and U.S. Provisional Patent Application No. 63/919,054 filed on Nov. 17, 2025, which are hereby incorporated by reference in their entirety.

### TECHNICAL FIELD

The present disclosure relates generally to wireless communication systems and, more specifically, the present disclosure is related to channel state information (CSI) reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to CSI reporting.

In one embodiment, a user equipment (UE) is provided. The UE includes a transceiver configured to receive information for a candidate cell and a processor operably coupled with the transceiver. The processor is configured to identify whether the information includes a CSI report configuration for CSI acquisition, identify, when the information includes the CSI report configuration, one or more resource settings for CSI acquisition associated with the CSI report configuration, identify, based on the one or more resource settings, channel and interference measurement resources related to CSI acquisition for the candidate cell, and determine a CSI report for the candidate cell based on the identified channel and interference measurement resources. The transceiver is further configured to transmit the CSI report.

In another embodiment, a base station (BS) is provided. The BS includes a processor and a transceiver operably coupled with the processor. The transceiver is configured to transmit information for a candidate cell and receive a CSI report for the candidate cell. The information includes a CSI report configuration for CSI acquisition. The information indicates one or more resource settings for CSI acquisition associated with the CSI report configuration. The one or more resource settings indicate channel and interference measurement resources related to CSI acquisition for the candidate cell. The CSI report based on the channel and interference measurement resources.

In yet another embodiment, a method performed by a user equipment is provided. The method includes receiving information for a candidate cell, identifying whether the information includes a CSI report configuration for CSI acquisition, and identifying, when the information includes the CSI report configuration, one or more resource settings for CSI acquisition associated with the CSI report configuration. The method further includes identifying, based on the one or more resource settings, channel and interference measurement resources related to CSI acquisition for the candidate cell, determining a CSI report for the candidate cell based on the identified channel and interference measurement resources, and transmitting the CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example beam operation in a wireless communication system according to embodiments of the present disclosure;

FIG. 5B illustrates an example multi-beam operation in a wireless communication system according to embodiments of the present disclosure;

FIG. 6 illustrates an example of a transmitter structure for beamforming according to embodiments of the present disclosure;

FIG. 7 illustrates an example synchronization signal block (SSB) utilized in a cell search procedure according to embodiments of the present disclosure;

FIG. 8 illustrates examples of Type-1 random access procedures according to embodiments of the present disclosure;

FIG. 9 illustrates examples of Type-2 random access procedures according to embodiments of the present disclosure; and

FIG. 10 illustrates an example method performed by a UE in a wireless communication system according to embodiments of the present disclosure.

### DETAILED DESCRIPTION

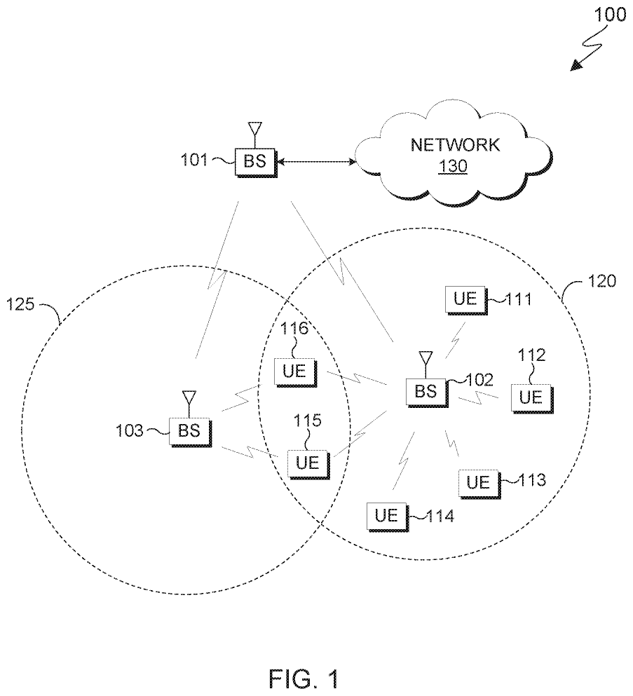

FIGS. 1-10 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v16.1.0, “NR; Physical channels and modulation” (herein, “REF 1”); 3GPP TS 38.212 v16.1.0, “NR; Multiplexing and Channel coding” (herein, “REF 2”); 3GPP TS 38.213 v16.1.0, “NR; Physical Layer Procedures for Control” (herein, “REF 3”); 3GPP TS 38.214 v16.1.0, “NR; Physical Layer Procedures for Data” (herein, “REF 4”); 3GPP TS 38.321 v16.1.0, “NR; Medium Access Control (MAC) protocol specification” (herein, “REF 5”); and 3GPP TS 38.331 v16.1.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques, although other OFDM-based transmission waveforms or multiple access schemes such as filtered OFDM (F-OFDM) can be used. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station (aNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing CSI reporting. In certain embodiments, one or more of the BSs 101-103 include circuitry, programing, or a combination thereof to utilize CSI reporting.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

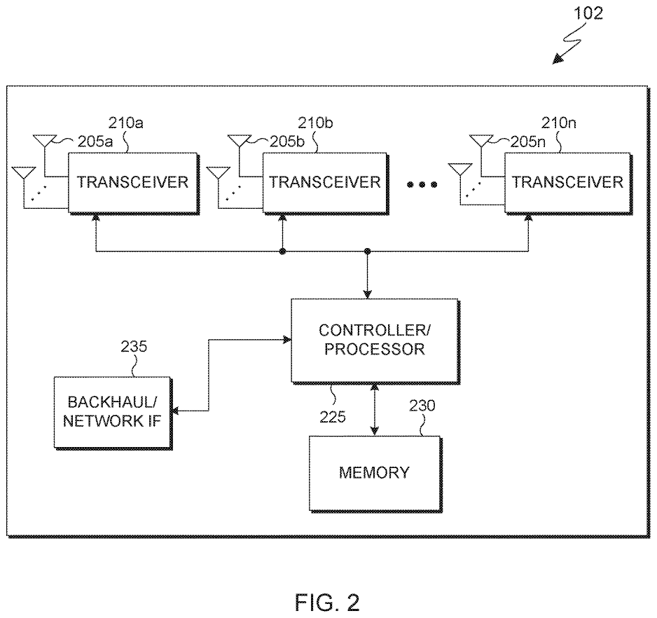

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. In the present disclosure, both frequency division duplexing (FDD) and time division duplexing (TDD) are considered as a duplex method for DL and UL signaling. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for utilizing CSI reporting. Any of a wide variety of other functions could be supported in the BS 102 by the controller/processor 225.

The controller/processor 225 is also capable of executing programs and other processes resident in the memory 230, such as processes to utilize CSI reporting. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

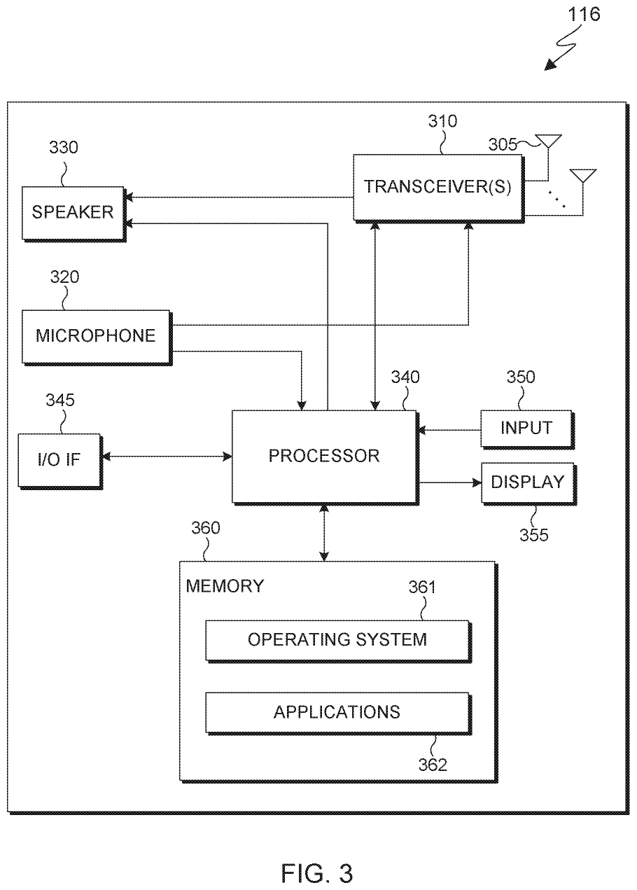

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing CSI reporting as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

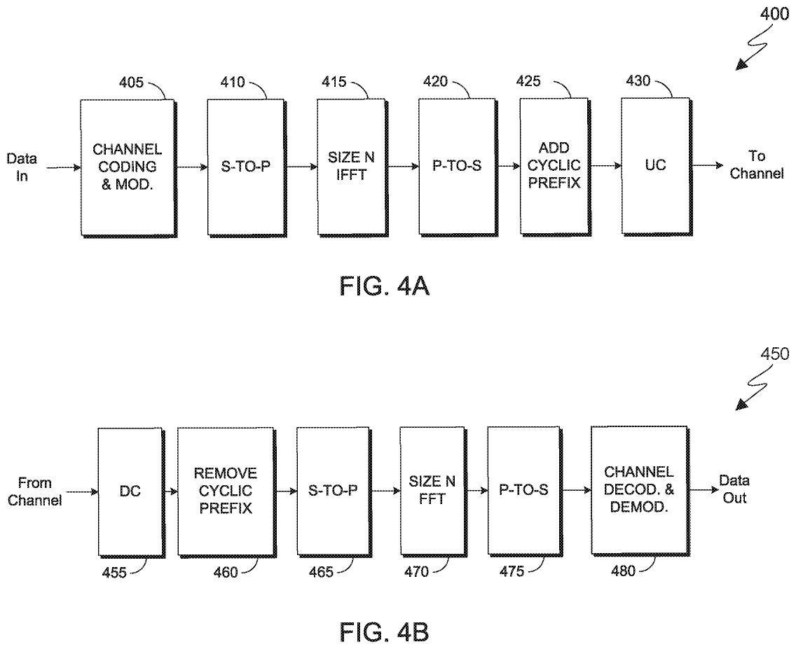

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting CSI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In this disclosure, a beam is determined by either of:
A transmission configuration indicator (TCI) state, that establishes a quasi-colocation (QCL) relationship between a source reference signal (e.g. SSB and/or CSI-RS) and a target reference signal
A spatial relation information that establishes an association to a source reference signal, such as SSB or CSI-RS or SRS.
   In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

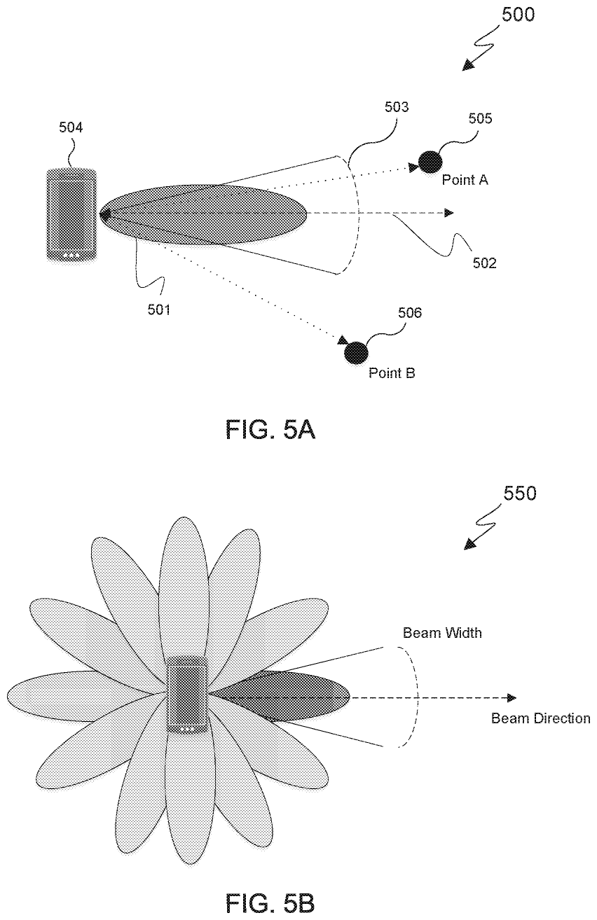

FIG. 5A illustrates an example beam operation 500 in a wireless communication system according to embodiments of the present disclosure. For example, beam operation 500 can be implemented by BS 102 and/or any of the UEs 111-116 of FIG. 1. This example is for illustration only and other embodiments can be used without departing from the scope of the present disclosure.

As illustrated in FIG. 5A, in a wireless system, a beam (501), for a device (504), can be characterized by a beam direction (502) and a beam width (503). For example, a device (504) transmits radio frequency (RF) energy in a beam direction and within a beam width. A device (504) receives RF energy in a beam direction and within a beam width. As illustrated in FIG. 5A, a device at point A (505) can receive from and transmit to device (504) as Point A is within a beam width and direction of a beam from device (504). As illustrated in FIG. 5A, a device at point B (506) cannot receive from and transmit to device (504) as Point B is outside a beam width and direction of a beam from device (504). While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example multi-beam operation 550 in a wireless communication system according to embodiments of the present disclosure. For example, multi-beam operation 550 can be implemented by BS 102 and/or any of the UEs 111-116 of FIG. 1. This example is for illustration only and other embodiments can be used without departing from the scope of the present disclosure.

As illustrated in FIG. 5B, in a wireless system, a device can transmit and/or receive on multiple beams. This is known as “multi-beam operation.” While FIG. 5B, for illustrative purposes, shows beams in 2D, it should be apparent to those skilled in the art that beams can be 3D, where the beams can be transmitted to or received from any direction in space.

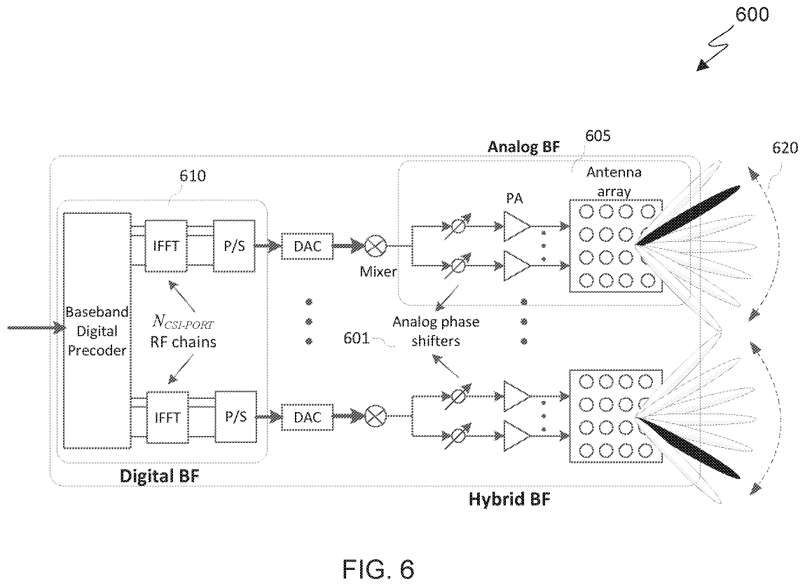

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

Rel-17 introduced the unified TCI framework, where a unified master or main or indicated TCI state is signaled to the UE. The unified or master or main or indicated TCI state can be one of:
1. In the case of joint TCI state indication, wherein a same beam is used for DL and UL channels, a joint TCI state that can be used at least for UE-dedicated DL channels and UE-dedicated UL channels.
2. In the case of separate TCI state indication, wherein different beams are used for DL and UL channels, a DL TCI state that can be used at least for UE-dedicated DL channels.
3. In the case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

The above-mentioned quasi-co-location (QCL) relation, can be quasi-location with respect to one or more of the following relations [REF 4—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and consists of 4 consecutive symbols, and 20 physical resource blocks (RBs) (240 subcarriers).

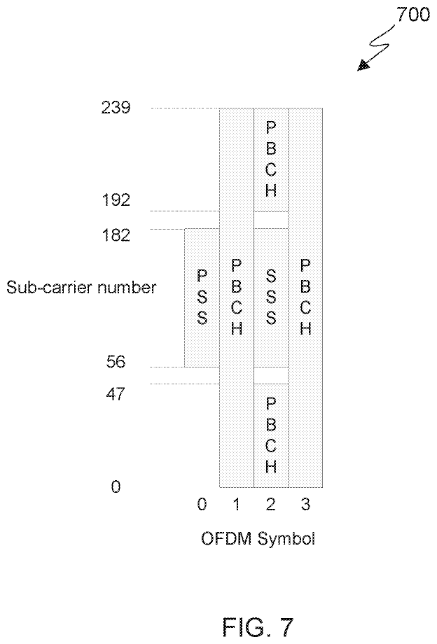

FIG. 7 illustrates an example SSB 700 utilized in a cell search procedure according to embodiments of the present disclosure. For example, SSB 700 can be transmitted by BS 102 or received by any one of the UEs 111-116 of FIG. 1. This example is for illustration only and other embodiments can be used without departing from the scope of the present disclosure.

As illustrated in FIG. 7, SSB 700 consists of 4 consecutive symbols, and 20 resource blocks (240 subcarriers). Further, the structure of SSB 700 is shown. The first symbol includes the primary synchronization signal (PSS) mapped to the 12 middle RBs of the SSB. The 4 outer RBs of the first symbol of the SSB at each edge are empty. The third symbol includes the secondary synchronization signal (SSS) mapped to the 12 middle RBs of the SSB. The second and fourth symbols as well as the 4 outer RBs of the SSBs of the third are mapped to PBCH. For a 3 MHz channel bandwidth, the PBCH is further punctured equally from both edges to span 144 subcarriers (i.e., 12 RBs).

SSBs are organized in groups of N SSBs, transmitted within half a frame, each SSB within the group has an index i, where i=0, 1, . . . , N−1, within each group of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH consists of a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depend or the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of REF 1.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [REF 3]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, Type-1 random access procedure and Type-2 random access procedure.

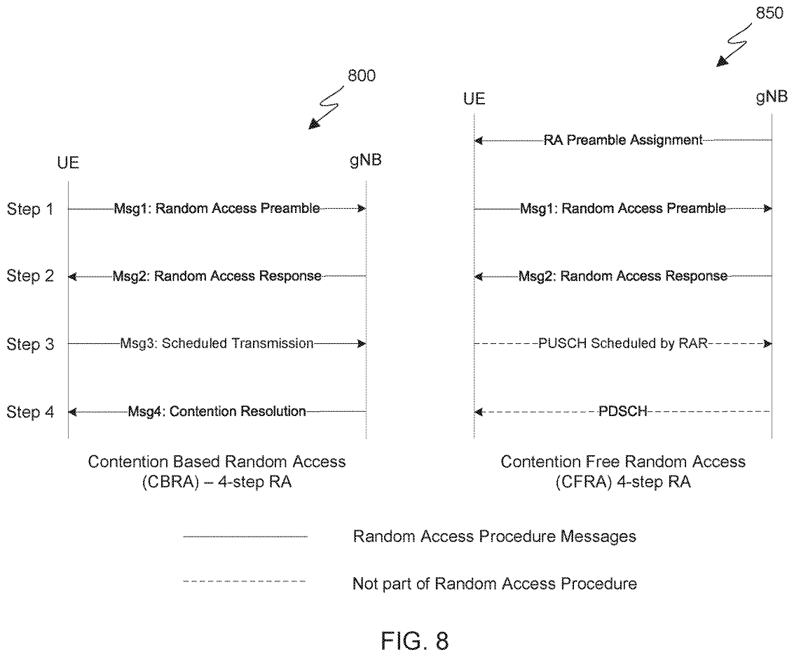

FIG. 8 illustrates examples of Type-1 random access procedures 800 and 850 according to embodiments of the present disclosure. For example, Type-1 random access procedures 800 and 850 can be implemented by BS 102 and any one of the UEs 111-116 of FIG. 1. These examples are for illustration only and other embodiments can be used without departing from the scope of the present disclosure.

A Type-1 random access procedure is known as the four-step random access procedure (4-step RACH). As illustrated in FIG. 8:
In step 1, the UE transmits a random access preamble, also known as Msg1, to the BS. The BS attempts to receive and detect the preamble.
In step 2, the BS upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the BS upon receiving the RRC setup request message, allocates downlink and uplink resources that are transmitted in a downlink PDSCH transmission to the UE.
   After the last step, the UE can proceed with reception and transmission of data traffic.

A Type-1 random access procedure (4-step RACH) can be contention based random access (CBRA) (i.e., Type-1 random access procedure 800) or contention free random access (CFRA) (i.e., Type-1 random access procedure 850). The CFRA procedure ends after the random access response, the following messages are not part of the random access procedure. For CFRA, in step 0, the BS indicates to the UE the preamble to use. Rel-16 introduced another random access procedure.

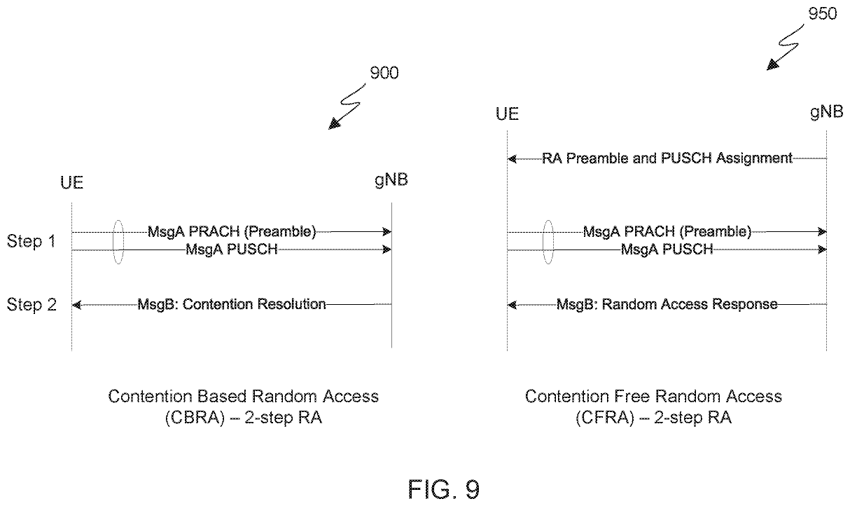

FIG. 9 illustrates examples of Type-2 random access procedures 900 and 950 according to embodiments of the present disclosure. For example, Type-2 random access procedures 900 and 950 can be implemented by BS 102 and any one of the UEs 111-116 of FIG. 1. These examples are for illustration only and other embodiments can be used without departing from the scope of the present disclosure.

A Type-2 random access procedure is known as the 2-step random access procedure (2-step RACH). As illustrated in FIG. 9, the procedure combines the preamble and PUSCH transmission into a single transmission from the UE to the BS, which is known as MsgA. Similarly, the RAR and the PDSCH transmission (e.g., Msg4) are combined into a single downlink transmission from the BS to the UE, which is known as MsgB.

A random access procedure can be triggered for initial access from the RRC_IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Channel state information reference signal is a downlink reference signal that is used for obtaining the downlink channel condition between the BS and the UE. CSI-RS can be transmitted independent of data transmissions on the downlink. The CSI-RS usage can be CSI-RS of beam management, CSI-RS for tracking, CSI-RS for CSI and etc.

In NR, CSI-RS resources including SSB(s) and/or NZP CSI-RS resource(s) are configured by the network for example as part of RRC setup or RRC reconfiguration. CSI-RS resources are configured in a CSI resource set provided/configured in a CSI resource setting, which could also be linked/associated/specific to a CSI reporting setting. The configuration of the CSI-RS resource includes at least the following: (1) information related to the time-frequency resource mapping of the CSI-RS resource, (2) information related to resource type of the CSI-RS resource including ‘periodic’, ‘aperiodic’, and ‘semi-persistent’, (3) information related to usage of the CSI-RS resource (e.g., for beam management, tracking, CSI and etc.), (4) information related to transmit power control parameter(s)/setting(s), (5) scrambling ID, and (7) information related to the TCI state.

This disclosure considers early triggering of CSI measurement/reporting for layer-1/layer-2 (L1/L2) triggered mobility (LTM). Early CSI measurement/reporting can assist in determining the channel conditions and better link adaptation and better precoding for downlink and uplink transmissions.

Note that in the present disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE or (3) UE-group RRC signaling. In addition, MAC CE signaling can be UE-specific e.g., to one UE and can be UE common (e.g., to a group of UEs). MAC CE signaling can be DL MAC CE signaling or UL MAC CE signaling. Furthermore, L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE and can be UE common (e.g., to a group of UEs).

Further in the present disclosure, the term “activation” describes an operation wherein a UE receives and decodes a signal from the network (or BS) that signifies a starting point in time. The starting point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal. The term “deactivation” describes an operation wherein a UE receives and decodes a signal from the network (or BS) that signifies a stopping point in time. The stopping point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used. A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/BS receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/BS receives the source RS, the NW/BS can measure and calculate the needed information to assign a particular DL (or/and UL) TX beam to the UE, for example in case of channel reciprocity.

Further in the present disclosure, DCI Format is used for L1 control information in the DL direction from BS to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). Furthermore, a higher layer message (e.g., SIB-based or RRC-based or MAC CE-based) can be carried by a physical downlink shared channel (PDSCH). In one example, the PDSCH can be scheduled by a DCI format.

As introduced above, the present disclosure provides L1/L2 triggered mobility (LTM).

After a UE receives an initial higher layer configuration of dl-OrJointTCI-StateList where more than one TCI-State can be used as an indicated TCI state and before application of an indicated TCI state from the configured TCI states:
The UE assumes that DM-RS of PDSCH and DM-RS of PDCCH that are not received during the RACH procedure, and the CSI-RS applying the indicated TCI state are quasi co-located with the reference signal(s) in the CandidateTCI-State indicated in the LTM Cell Switch Command MAC CE if applicable,
   otherwise,
The UE assumes that DM-RS of PDSCH and DM-RS of PDCCH and the CSI-RS applying the indicated TCI state are quasi co-located with the SS/PBCH block the UE identified during the initial access procedure.

After a UE receives an initial higher layer configuration of dl-OrJointTCI-StateList where more than one TCI-State can be used as an indicated TCI state or an initial higher layer configuration of ul-TCI-StateList where more than one TCI-UL-State can be used as an indicated TCI state and before application of an indicated TCI state from the configured TCI states:
The UE determines the UL TX spatial filter, if applicable, for dynamic-grant based PUSCH that is not transmitted during the RACH procedure and configured-grant based PUSCH and PUCCH that are not transmitted during the RACH procedure, and for SRS applying the indicated TCI state, from the CandidateTCI-State or CandidateTCI-UL-State indicated in the LTM Cell Switch Command MAC CE if applicable,
   otherwise,
The UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant or a MsgA PUSCH transmission during the initial access procedure.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after

$$slot n + 3 {N}_{slot}^{subframe , μ} + \frac{{2}^{μ}}{{2}^{μ {K}_{mac}}} \cdot {k}_{mac}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command,
the UE assumes that DM-RS of ports of PDSCH of a serving cell are quasi co-located with the reference signal(s) in the CandidateTCI-State indicated in the LTM Cell Switch Command MAC CE, except during RACH procedure for RACH-based LTM, if applicable,
   otherwise,
the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

For CQI, PMI, CRI, SSBRI, LI, RI, L1-RSRP, L1-SINR, CapabilityIndex, TDCP a UE is configured by higher layers with N≥1 CSI-ReportConfig Reporting Settings and/or X≥1 LTM-CSI-ReportConfig Reporting Settings, M≥1 CSI-ResourceConfig Resource Settings and/or Y≥1 LTM-CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs or LTM-CSI-ReportConfigs indicating the Resource Set IDs for channel and optionally for interference where a Resource Set for interference can only be present for a Report Setting given by a CSI-ReportConfig and a trigger state additionally contains one or more CSI-ReportSubConfigId if the associated CSI-ReportConfig configured with a list of sub-configurations. Each trigger state in CSI-SemiPersistentOnPUSCH-TriggerStateList contains one associated CSI-ReportConfig or LTM-CSI-ReportConfig, and a trigger state additionally contain one or more CSI-ReportSubConfigId if the associated CSI-ReportConfig is configured with a list of sub-configurations.

Each Reporting Setting ltm-CSI-ReportConfig is associated with a LTM-CSI-ResourceConfig for channel measurement and contains the parameters(s) for time-domain behavior provided by ltm-ReportConfigType, the number of cells and the number of reference signals per candidate cell provided by nrOfReportedCells, and nrOfReportedRS-PerCell, respectively, when ltm-ReportConfigType set to ‘periodic’ or ‘semiPersistentOnPUCCH’ or ‘semiPersistentOnPUSCH’ or ‘aperiodic’, comprising L1 measurement results associated with current SpCell if spCellInclusion is configured, and the CSI-related quantities to be reported by the UE provided by reportQuantity, if configured.

The time domain behavior of LTM-CSI-ReportConfig is indicated by the higher layer parameter ltm-ReportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on.

Each LTM CSI Resource Setting LTM-CSI-ResourceConfig contains either configuration of a ltm-CSI-SSB-ResourceSet or a ltm-NZP-CSI-RS-ResourceSet.
A ltm-CSI-SSB-ResourceSet comprises of a list of Z≥1 SS/PBCH blocks indices (given by ltm-CSI-SSB-ResourceList) and a list of Z LTM-CandidateIds (given by ltm-CandidateIdList) referring to candidate cells associated with the SS/PBCH block indices. For each candidate cell, the UE determines the time domain behavior of a SS/PBCH block from ssb-Periodicity and ssb-PositionsInBurst and the frequency domain behavior of a SS/PBCH block is determined by the higher layer parameters subcarrierSpacing, ssb-Frequency.
A ltm-NZP-CSI-RS-ResourceSet comprises of a list of Z≥1 NZP CSI-RS resource indices (given by ltm-CSI-NZP-CSI-RS-ResourceList) and a list of Z LTM-CandidateIds (given by ltm-CandidateIdList) referring to candidate cells associated with the NZP CSI-RS resource indices. The UE may expect that the NZP CSI-RS resources in ltm-NZP-CSI-RS-ResourceSet are configured with the higher layer parameter repetition set to ‘off’. When/if the list of Z LTM-CandidateIds (given by ltm-CandidateIdList) are absent or not provided/configured/present in/from the ltm-NZP-CSI-RS-ResourceSet, the UE could determine a candidate cell associated with a NZP CSI-RS resource index in the list of Z≥1 NZP CSI-RS resource indices (given by ltm-CSI-NZP-CSI-RS-ResourceList) according to or based on or as a/the (same) candidate cell associated with a SSB that is QCLed with the NZP CSI-RS resource having the NZP CSI-RS resource index; herein:
   In one example, a/the (same) candidate cell could correspond to an entry (or a candidate cell ID/index) in or from a/the list of Z LTM-CandidateIds (given by ltm-CandidateIdList) provided or configured or comprised in/from a ltm-CSI-SSB-ResourceSet associated with the SSB corresponding to an entry in or from a list of Z≥1 SS/PBCH blocks indices (given by ltm-CSI-SSB-ResourceList) provided or configured or comprised in/from the (same) CSI-SSB-ResourceSet.
   In another example, a (configured or activated or indicated) TCI state provided by TCI-State that provides or configures the SSB as a/the QCL source RS could also comprise a candidate cell ID/index corresponding to a/the (same) candidate cell and the NZP CSI-RS resource having the NZP CSI-RS resource index as a/the QCL target RS. For this example, the candidate cell ID/index could be in/from a list of candidate cell ID(s)/index(es) provided by LTM-CandidateIds or ltm-CandidateIdList.
Furthermore, the UE could expect that a/the same candidate cell (or candidate cell ID/index) associated with the NZP CSI-RS resource/resource index and the SSB QCL'ed with the NZP CSI-RS resource having the NZP CSI-RS resource index, wherein the UE could determine the association between the SSB and the (same) candidate cell (or the corresponding candidate cell ID/index) according to or following those specified/defined herein in the present disclosure. In addition, the downlink CSI-RS EPRE can be derived from the SS/PBCH block downlink transmit power given by the parameter ss-PBCH-BlockPower-r18 in LTM-SSB-Config-r18 and CSI-RS power offset given by the parameter powerControlOffsetSS provided by higher layers if the SS/PBCH block and the CSI-RS are associated with a/the same candidate cell (or candidate cell ID/index) according to or following those specified/defined herein in the present disclosure, where the CSI-RS could be QCLed with the SS/PBCH block. The downlink reference-signal transmit power is defined as the linear average over the power contributions (in [W]) of the resource elements that carry the configured CSI-RS within the operating system bandwidth. As specified/defined herein in the present disclosure, a/the candidate cell ID/index could be in/from a list of candidate cell ID(s)/index(es) provided by LTM-CandidateIds or ltm-CandidateIdList.

For a report setting ltm-CSI-ReportConfig configured with ltm-ReportConfigType set to ‘periodic’ or ‘semiPersistentOnPUCCH’ or ‘semiPersistentOnPUSCH’ or ‘aperiodic’, the time domain behavior of the NZP CSI-RS resources within a ltm-NZP-CSI-RS-ResourceSet are indicated by the higher layer parameter resourceType.

For a UE configured with LTM-CSI-ReportConfig, the aperiodic, semi-persistent or periodic CSI are associated with one Resource Setting given by ltm-ResourcesForChannelMeasurement for L1-RSRP measurement.

A UE may be configured with a ltm-CSI-ReportConfig with a higher layer parameter reportQuantity set to either ‘cri-RSRP’ or ‘ssb-Index-RSRP’.

If a UE is configured with a ltm-CSI-ReportConfig with ltm-ReportConfigType which is set to ‘periodic’ or ‘semiPersistentOnPUCCH’ or ‘semiPersistentOnPUSCH’ or ‘aperiodic’:
if the UE is configured with spCellInclusion with reportQuantity set to ‘ssb-Index-RSRP’, the UE could report in a single reporting instance nrOfReportedRS-PerCell different SSBRI for the current SpCell and each of the nrOfReportedCells−1 candidate cells. Otherwise, the UE could report in a single reporting instance nrOfReportedRS-PerCell different SSBRI for each of the nrOfReportedCells candidate cells,
   where SSBRI k (k≥0) corresponds to the configured (k+1)-th entry of the associated ltm-CSI-SSB-ResourceList in the corresponding ltm-CSI-SSB-ResourceSet,
      if spCellInclusion is configured, SSB resources in ltm-CSI-SSB-ResourceList associated with the current SpCell are the entries where PCI (given by ltm-CandidatePCI) and frequency information (given by ssb-Frequency) of the candidate cell associated with the LTM-CandidateId (given by the corresponding entry in ltm-CandidateIdList) is equal to the PCI and center frequency of cell-defining SSB of the current SpCell.
if the UE is configured with spCellInclusion with reportQuantity set to ‘cri-RSRP’, the UE could report in a single reporting instance nrOfReportedRS-PerCell different CRI for the current SpCell and each of the nrOfReportedCells−1 candidate cells. Otherwise, the UE could report in a single reporting instance nrOfReportedRS-PerCell different CRI for each of the nrOfReportedCells candidate cells,
   where CRI k (k≥0) corresponds to the configured (k+1)-th entry of the associated ltm-CSI-NZP-CSI-RS-ResourceList in the corresponding ltm-CSI-NZP-CSI-RS-ResourceSet, if spCellInclusion is configured.
      In one example, NZP CSI-RS resources in ltm-CSI-NZP-CSI-RS-ResourceList associated with the current SpCell are the entries where PCI (given by ltm-CandidatePCI) and frequency information (given by ssb-Frequency) of the candidate cell associated with the LTM-CandidateId (given by the corresponding entry in ltm-CandidateIdList) is equal to the PCI and center frequency of cell-defining SSB of the current SpCell.
      In another example, NZP CSI-RS resources in ltm-CSI-NZP-CSI-RS-ResourceList associated with the current SpCell are the entries QCL'ed with SS/PBCH resources, where PCI (given by ltm-CandidatePCI) and frequency information (given by ssb-Frequency) of the candidate cell—associated with the LTM-CandidateId (given by the corresponding entry in ltm-CandidateIdList)—associated with the SS/PBCH resources is equal to the PCI and center frequency of cell-defining SSB of the current SpCell; herein, the UE could determine or identify the association between the SS/PBCH resources and the candidate cell according to or following those specified/defined herein in the present disclosure.
      In another example, NZP CSI-RS resources in ltm-CSI-NZP-CSI-RS-ResourceList associated with the current SpCell are the entries where PCI (given by ltm-CandidatePCI) and frequency information (absoluteFrequencyPointA) of the candidate cell associated with the LTM-CandidateId (given by the corresponding entry in ltm-CandidateIdList) is equal to the PCI and frequency associated with point A of the current SpCell.

For a report setting ltm-CSI-ReportConfig configured with ltm-ReportConfigType set to ‘eventTriggered’, the UE may expect that the time domain behavior of the NZP CSI-RS resources within a ltm-NZP-CSI-RS-ResourceSet is periodic when the LTM-CSI-ResourceConfig contains a configuration of a ltm-CSI-NZP-CSI-RS-ResourceSet. When the UE is configured with dl-OrJointTCI-StateList or ul-TCI-StateList, for the L1-RSRP of the serving cell (or spCell) RS:
if the LTM-CSI-ResourceConfig contains a configuration of a ltm-CSI-NZP-CSI-RS-ResourceSet, the UE measures the L1-RSRP of the reference signal in the indicated TCI state provided in a NZP-CSI-RS-ResourceSet configured with repetition,
if the LTM-CSI-ResourceConfig contains a configuration of a ltm-CSI-SSB-ResourceSet, the UE measures the L1-RSRP of the SS/PBCH block which is QCLed with the reference signal in the indicated TCI state,
   where the reference signal in the indicated TCI state is the reference signal w.r.t. QCL-TypeD, if there are two QCL RSs in the indicated TCI state.

A UE configured with LTM-Config can be provided configurations for CSI acquisition, by up to one Reporting Setting, ltm-eCSI-ReportConfig, for a candidate cell. Each Reporting Setting ltm-eCSI-ReportConfig is associated with a single ltm-NZP-CSI-RS-ResourceSet-eCSI for channel measurements, wherein the UE could expect that the ltm-NZP-CSI-RS-ResourceSet-eCSI is configured without higher layer parameter trs-Info and without the higher layer parameter repetition. The ltm-NZP-CSI-RS-ResourceSet-eCSI provides a list of NZP CSI-RS resources. The UE could expect the following configuration provided by ltm-eCSI-ReportConfig:
For the frequency granularity of the CSI report, the CQI format indicator is Wideband CQI.
For the frequency granularity of the CSI report, the PMI format indicator is Wideband PMI.
The codebook type is typeI-SinglePanel.
No more than 128 NZP CSI-RS ports may be configured in the NZP CSI-RS Resource Set.
The reportQuantity is set to ‘cri-RI-PMI-CQI’.

When a UE is provided a candidate cell for cell switch by an LTM Cell Switch Command MAC CE [10, REF 5]—in this case, the UE could expect or assume that at least one of the CSI-RS(s)/CSI-RS resource(s)—e.g., as QCL source RS(s)/RS resource(s)—configured or provided in a/the TCI state—e.g., provided/configured by CandidateTCI-State or CandidateTCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured without higher layer parameter trs-Info and without the higher layer parameter repetition, or the UE may not expect or assume that all of the CSI-RS(s)/CSI-RS resource(s)—e.g., as QCL source RS(s)/RS resource(s)—configured or provided in a/the TCI state—e.g., provided/configured by CandidateTCI-State or CandidateTCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured with higher layer parameter trs-Info and/or the higher layer parameter repetition, and a ltm-eCSI-ReportConfig is configured for the candidate cell, the UE could measure corresponding NZP CSI-RS resource(s) according to or following or based on one or more of:
(setting-1): one or more (or all) of the NZP CSI-RS resource(s) in the (single) ltm-NZP-CSI-RS-ResourceSet-eCSI for channel measurement—associated with the Reporting Setting ltm-eCSI-ReportConfig
(setting-2): one or more (or all) of the NZP CSI-RS resource(s) in the (single) ltm-NZP-CSI-RS-ResourceSet-eCSI for channel measurement—associated with the Reporting Setting ltm-eCSI-ReportConfig—that have the same value(s) as the CSI-RS(s)/CSI-RS resource(s)—e.g., as QCL source RS(s)/RS resource(s)—configured or provided in a/the TCI state—e.g., provided/configured by CandidateTCI-State or CandidateTCI-UL-State—indicated in/by the LTM Cell Switch Command MAC CE for the candidate cell for cell switch; or the CSI-RS(s)/CSI-RS resource(s)—e.g., as QCL source RS(s)/RS resource(s)—configured or provided in a/the TCI state—e.g., provided/configured by CandidateTCI-State or Candidate TCI-UL-State—indicated in/by the LTM Cell Switch Command MAC CE for the candidate cell for cell switch from the (single) ltm-NZP-CSI-RS-ResourceSet-eCSI for channel measurement—associated with the Reporting Setting ltm-eCSI-ReportConfig, after a LTM beam application time (i.e., after when a/the TCI state indicated in/by the LTM Cell Switch Command MAC CE for the candidate cell for cell switch is applied or becomes applicable)
   according to or based on or following: (i) fixed rule(s)/value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to corresponding UE's capability(s) or capability signaling(s), and/or (iii) UE's autonomous determination, selection and/or identification, which could be further indicated or transmitted or sent to the network via various UL channels/signals including CSI report(s), UE's capability signaling(s) and/or etc.

In one example, when/if a/the higher layer parameter eCSI-MeasIndicatedTCI is provided or configured or present and/or set to ‘enabled’, the UE could follow setting-2 as specified/defined herein in the present disclosure to determine or identify the corresponding NZP CSI-RS resource(s) for channel measurement(s); otherwise, e.g., when/if a/the higher layer parameter eCSI-MeasIndicatedTCI is not provided or configured or present or is absent or is provided or configured or present but set to ‘disabled’, the UE could follow setting-1 as specified/defined herein in the present disclosure to determine or identify the corresponding NZP CSI-RS resource(s) for channel measurement(s).

In another example, when/if the number of NZP CSI-RS resource(s) in the (single) ltm-NZP-CSI-RS-ResourceSet-eCSI for channel measurement—associated with the Reporting Setting ltm-eCSI-ReportConfig—is greater than or equal to a threshold or number of value, the UE could follow setting-2 as specified/defined herein in the present disclosure to determine or identify the corresponding NZP CSI-RS resource(s) for channel measurement(s); otherwise, e.g., when/if the number of NZP CSI-RS resource(s) in the (single) ltm-NZP-CSI-RS-ResourceSet for channel measurement—associated with the Reporting Setting ltm-eCSI-ReportConfig—is lower than or equal to a threshold or number of value, the UE could follow setting-1 as specified/defined herein in the present disclosure to determine or identify the corresponding NZP CSI-RS resource(s) for channel measurement(s). For this example, the UE could determine or identify the threshold/number/value as specified/defined herein in the present disclosure according to or based on or following: (i) fixed rule(s)/value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to corresponding UE's capability(s) or capability signaling(s), and/or (iii) UE's autonomous determination, selection and/or identification, which could be further indicated or transmitted or sent to the network via various UL channels/signals including CSI report(s), UE's capability signaling(s) and/or etc.

In another example, when/if at least one of the CSI-RS(s)/CSI-RS resource(s)—e.g., as QCL source RS(s)/RS resource(s)—configured or provided in a/the TCI state—e.g., provided/configured by CandidateTCI-State or Candidate TCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured without higher layer parameter trs-Info and without the higher layer parameter repetition, the UE could follow setting-2 as specified/defined herein in the present disclosure to determine or identify the corresponding NZP CSI-RS resource(s) for channel measurement(s); otherwise, e.g., (i) when/if none of the CSI-RS(s)/CSI-RS resource(s)—e.g., as QCL source RS(s)/RS resource(s)—configured or provided in a/the TCI state—e.g., provided/configured by Candidate TCI-State or CandidateTCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured without higher layer parameter trs-Info and without the higher layer parameter repetition and/or (ii) all of the CSI-RS(s)/CSI-RS resource(s)—e.g., as QCL source RS(s)/RS resource(s)—configured or provided in a/the TCI state—e.g., provided/configured by CandidateTCI-State or Candidate TCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured with higher layer parameter trs-Info and/or the higher layer parameter repetition, the UE could follow setting-1 as specified/defined herein in the present disclosure to determine or identify the corresponding NZP CSI-RS resource(s) for channel measurement(s).

In another example, when/if one or more of the CSI-RS(s)/CSI-RS resource(s)—e.g., as QCL source RS(s)/RS resource(s)—configured or provided in a/the TCI state—e.g., provided/configured by CandidateTCI-State or Candidate TCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured with higher layer parameter trs-Info, the UE could follow setting-2 as specified/defined herein in the present disclosure to determine or identify the corresponding NZP CSI-RS resource(s) for channel measurement(s); otherwise, the UE could follow setting-1 as specified/defined herein in the present disclosure to determine or identify the corresponding NZP CSI-RS resource(s) for channel measurement(s).

In another example, when/if one or more of the CSI-RS(s)/CSI-RS resource(s)—e.g., as QCL source RS(s)/RS resource(s)—configured or provided in a/the TCI state—e.g., provided/configured by CandidateTCI-State or Candidate TCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured with the higher layer parameter repetition, the UE could follow setting-2 as specified/defined herein in the present disclosure to determine or identify the corresponding NZP CSI-RS resource(s) for channel measurement(s); otherwise, the UE could follow setting-1 as specified/defined herein in the present disclosure to determine or identify the corresponding NZP CSI-RS resource(s) for channel measurement(s).

When/if the UE follows setting-2 as specified/defined herein in the present disclosure to determine or identify the corresponding NZP CSI-RS resource(s) for channel measurement(s),
for example, the UE could expect that the CSI-RS(s)/CSI-RS resource(s)—e.g., as QCL source RS(s)/RS resource(s)—configured or provided in a/the TCI state—e.g., provided/configured by CandidateTCI-State or CandidateTCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured without higher layer parameter trs-Info and without the higher layer parameter repetition;
for another example, the UE may not expect that the CSI-RS(s)/CSI-RS resource(s)—e.g., as QCL source RS(s)/RS resource(s)—configured or provided in a/the TCI state—e.g., provided/configured by CandidateTCI-State or CandidateTCI-UL-State—indicated in/by the LTM Cell Switch Command MAC CE for the candidate cell for cell switch is in/from an NZP CSI-RS resource set (e.g., provided/configured by NZP-CSI-RS-ResourceSet) configured with higher layer parameter trs-Info and/or the higher layer parameter repetition,
   and transmit a CSI report to the candidate cell. If a valid CSI is not available, the UE could transmit a report which contains a CQI corresponding to the lowest CQI index.

According to or following those specified/defined herein in the present disclosure, a UE configured with LTM-Config can be provided configurations for CSI acquisition, by up to one Reporting Setting, ltm-eCSI-ReportConfig, for a candidate cell. Each Reporting Setting ltm-eCSI-ReportConfig is associated with a single ltm-NZP-CSI-RS-ResourceSet-eCSI for channel measurements, wherein the UE could expect that the ltm-NZP-CSI-RS-ResourceSet-eCSI is configured without higher layer parameter trs-Info and without the higher layer parameter repetition. The ltm-NZP-CSI-RS-ResourceSet-eCSI provides a list of NZP CSI-RS resources. The UE could expect the following configuration provided by ltm-eCSI-ReportConfig:
For the frequency granularity of the CSI report, the CQI format indicator is Wideband CQI.
For the frequency granularity of the CSI report, the PMI format indicator is Wideband PMI.
The codebook type is typeI-SinglePanel.
No more than 128 NZP CSI-RS ports may be configured in the NZP CSI-RS Resource Set.
The reportQuantity is set to ‘cri-RI-PMI-CQI’.

When/if a/the UE receives or is provided or indicated a candidate cell TCI states activation/deactivation MAC CE [6, REF 5] for a candidate cell such that the corresponding candidate cell ID is provided or indicated or comprised or contained or included in the candidate cell TCI states activation/deactivation MAC CE, and the UE would perform channel measurement(s)/reporting(s) for CSI acquisition based on one or more of the CSI-RS(s)/CSI-RS resource(s) provided or indicated or specific to TCI state(s) indicated or activated in/by the candidate cell TCI states activation/deactivation MAC CE command according to or following those specified/defined herein in the present disclosure, the UE could expect or assume that at least one of the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell is in/from an NZP CSI-RS resource set (e.g., provided/configured by NZP-CSI-RS-ResourceSet) configured without higher layer parameter trs-Info and without the higher layer parameter repetition, or the UE may not expect or assume that all of the CSI-RS(s)/CSI-RS resource(s)—e.g., as QCL source RS(s)/RS resource(s)—configured or provided in the TCI state(s)—e.g., provided/configured by Candidate TCI-State(s) or CandidateTCI-UL-State(s)—indicated or activated in/by the candidate cell TCI states activation/deactivation MAC CE for the candidate cell is in/from an NZP CSI-RS resource set (e.g., provided/configured by NZP-CSI-RS-ResourceSet) configured with higher layer parameter trs-Info and/or the higher layer parameter repetition. For a/the candidate cell configured with a corresponding ltm-eCSI-ReportConfig associated with ltm-NZP-CSI-RS-ResourceSet-eCSI—denoted by/as a/the candidate cell for CSI acquisition, the UE could measure the target NZP CSI-RS resource(s) for CSI acquisition as defined/specified herein in the present disclosure for the candidate cell according to or following or based on one or more of:
(setting-A): one or more (or all) of the NZP CSI-RS resource(s) in the (single) ltm-NZP-CSI-RS-ResourceSet-eCSI for channel measurement(s)—associated with the Reporting Setting ltm-eCSI-ReportConfig
(setting-B): one or more (or all) of the NZP CSI-RS resource(s) in the (single) ltm-NZP-CSI-RS-ResourceSet-eCSI for channel measurement(s)—associated with the Reporting Setting ltm-eCSI-ReportConfig—that have the same value(s) as the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell; or the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell from the (single) ltm-NZP-CSI-RS-ResourceSet-eCSI for channel measurement(s)—associated with the Reporting Setting ltm-eCSI-ReportConfig
   according to or based on or following: (i) fixed rule(s)/value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to corresponding UE's capability(s) or capability signaling(s), and/or (iii) UE's autonomous determination, selection and/or identification, which could be further indicated or transmitted or sent to the network via various UL channels/signals including CSI report(s), UE's capability signaling(s) and/or etc.

In one example, when/if a/the higher layer parameter eCSI-MeasActivatedTCI is provided or configured or present and/or set to ‘enabled’, the UE could follow setting-B as specified/defined herein in the present disclosure to determine or identify the target NZP CSI-RS resource(s) for CSI acquisition for the candidate cell; otherwise, e.g., when/if a/the higher layer parameter eCSI-MeasActivatedTCI is not provided or configured or present or is absent or is provided or configured or present but set to ‘disabled’, the UE could follow setting-A as specified/defined herein in the present disclosure to determine or identify the corresponding target CSI-RS resource(s) for CSI acquisition for the candidate cell.

In another example, when/if the UE receives a/the candidate cell TCI states activation/deactivation MAC CE for the candidate cell according to or following those specified/defined herein in the present disclosure, the UE could follow setting-B as specified/defined herein in the present disclosure to determine or identify the target NZP CSI-RS resource(s) for CSI acquisition for the candidate cell; otherwise, e.g., when/if the UE does not receive any candidate TCI states activation/deactivation MAC CE(s) for the candidate cell, the UE could follow setting-A as specified/defined herein in the present disclosure to determine or identify the corresponding target NZP CSI-RS resource(s) for CSI acquisition for the candidate cell.

In another example, when/if the number of NZP CSI-RS resource(s) in the (single) ltm-NZP-CSI-RS-ResourceSet-eCSI for channel measurement(s)—associated with the Reporting Setting ltm-eCSI-ReportConfig—for the candidate cell is greater than or equal to a threshold or number of value, the UE could follow setting-B as specified/defined herein in the present disclosure to determine or identify the corresponding target NZP CSI-RS resource(s) for CSI acquisition for the candidate cell; otherwise, e.g., when/if the number of NZP CSI-RS resource(s) in the (single) ltm-NZP-CSI-RS-ResourceSet for channel measurement(s)—associated with the Reporting Setting ltm-eCSI-ReportConfig—for the candidate cell is lower than or equal to a threshold or number of value, the UE could follow setting-A as specified/defined herein in the present disclosure to determine or identify the corresponding target NZP CSI-RS resource(s) for CSI acquisition for the candidate cell. For this example, the UE could determine or identify the threshold/number/value as specified/defined herein in the present disclosure according to or based on or following: (i) fixed rule(s)/value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to corresponding UE's capability(s) or capability signaling(s), and/or (iii) UE's autonomous determination, selection and/or identification, which could be further indicated or transmitted or sent to the network via various UL channels/signals including CSI report(s), UE's capability signaling(s) and/or etc.

In another example, when/if at least one of the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell is in/from an NZP CSI-RS resource set (e.g., provided/configured by NZP-CSI-RS-ResourceSet) configured without higher layer parameter trs-Info and without the higher layer parameter repetition, the UE could follow setting-B as specified/defined herein in the present disclosure to determine or identify the corresponding target NZP CSI-RS resource(s) for CSI acquisition for the candidate cell; otherwise, e.g., (i) when/if none of the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE is in/from an NZP CSI-RS resource set (e.g., provided/configured by NZP-CSI-RS-ResourceSet) configured without higher layer parameter trs-Info and without the higher layer parameter repetition and/or (ii) all of the CSI-RS(s)/CSI-RS resource(s)—e.g., as QCL source RS(s)/RS resource(s)—configured or provided in the TCI state(s)—e.g., provided/configured by CandidateTCI-State(s) or Candidate TCI-UL-State(s)—indicated in/by the candidate cell TCI states activation/deactivation MAC CE for the candidate cell is in/from an NZP CSI-RS resource set (e.g., provided/configured by NZP-CSI-RS-ResourceSet) configured with higher layer parameter trs-Info and/or the higher layer parameter repetition, the UE could follow setting-A as specified/defined herein in the present disclosure to determine or identify the corresponding target NZP CSI-RS resource(s) for CSI acquisition for the candidate cell.

In another example, when/if one or more of the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell is in/from an NZP CSI-RS resource set (e.g., provided/configured by NZP-CSI-RS-ResourceSet) configured with higher layer parameter trs-Info, the UE could follow setting-B as specified/defined herein in the present disclosure to determine or identify the corresponding target NZP CSI-RS resource(s) for CSI acquisition for the candidate cell; otherwise, the UE could follow setting-A as specified/defined herein in the present disclosure to determine or identify the corresponding target NZP CSI-RS resource(s) for CSI acquisition for the candidate cell.

In another example, when/if one or more of the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell is in/from an NZP CSI-RS resource set (e.g., provided/configured by NZP-CSI-RS-ResourceSet) configured with the higher layer parameter repetition, the UE could follow setting-B as specified/defined herein in the present disclosure to determine or identify the corresponding target NZP CSI-RS resource(s) for CSI acquisition for the candidate cell; otherwise, the UE could follow setting-A as specified/defined herein in the present disclosure to determine or identify the corresponding target NZP CSI-RS resource(s) for CSI acquisition for the candidate cell.

When/if the UE follows setting-B as specified/defined herein in the present disclosure to determine or identify the corresponding target NZP CSI-RS resource(s) for CSI acquisition for the candidate cell,
for example, the UE could expect that the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell is in/from an NZP CSI-RS resource set (e.g., provided/configured by NZP-CSI-RS-ResourceSet) configured without higher layer parameter trs-Info and without the higher layer parameter repetition;
for another example, the UE may not expect that the CSI-RS(s)/CSI-RS resource(s)—e.g., as QCL source RS(s)/RS resource(s)—configured or provided in the TCI state(s)—e.g., provided/configured by CandidateTCI-State(s) or CandidateTCI-UL-State(s)—indicated or activated in/by the candidate cell TCI states activation/deactivation MAC CE for the candidate cell is in/from an NZP CSI-RS resource set (e.g., provided/configured by NZP-CSI-RS-ResourceSet) configured with higher layer parameter trs-Info and/or the higher layer parameter repetition.

According to or following those specified/defined herein in the present disclosure, when/if a/the UE receives or is provided or indicated a candidate cell TCI states activation/deactivation MAC CE [6, REF 5] for a candidate cell such that the corresponding candidate cell ID is provided or indicated or comprised or contained or included in the candidate cell TCI states activation/deactivation MAC CE, and the UE would perform channel measurement(s)/reporting(s) for CSI acquisition based on one or more of the CSI-RS(s)/CSI-RS resource(s) provided or indicated or specific to TCI state(s) indicated or activated in/by the candidate cell TCI states activation/deactivation MAC CE command for the candidate cell according to or following those specified/defined herein in the present disclosure, the UE could expect to receive the candidate cell TCI states activation/deactivation MAC CE command for the candidate cell and/or the UE would expect that the candidate cell TCI states activation/deactivation MAC CE command could become applicable or could be applied no later than Y symbol(s)/slot(s)/etc. before receiving the LTM Cell Switch Command MAC CE and/or before the received LTM Cell Switch Command MAC CE is applied/becomes applicable and/or T_delay symbol(s)/slot(s)/etc. after the end (e.g., the last symbol/slot/etc.) of receiving/reception of the LTM Cell Switch Command MAC CE, wherein the UE could determine value(s) of Y according to or based on or following one or more of: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

According to or following those specified/defined herein in the present disclosure, for a UE configured with LTM-Config, the UE can be provided configurations for CSI acquisition, by up to one Reporting Setting, ltm-eCSI-ReportConfig, for a candidate cell. Each Reporting Setting ltm-eCSI-ReportConfig is associated with a single ltm-NZP-CSI-RS-ResourceSet-eCSI for (periodic) channel measurements, wherein the UE could expect that the ltm-NZP-CSI-RS-ResourceSet-eCSI is configured without higher layer parameter trs-Info and without the higher layer parameter repetition. The ltm-NZP-CSI-RS-ResourceSet-eCSI provides a list of NZP CSI-RS resources. The UE could expect the following configuration provided by ltm-eCSI-ReportConfig:
For the frequency granularity of the CSI report, the CQI format indicator is Wideband CQI.
For the frequency granularity of the CSI report, the PMI format indicator is Wideband PMI.
The codebook type is typeI-SinglePanel.
No more than 128 NZP CSI-RS ports may be configured in the NZP CSI-RS Resource Set.
The reportQuantity is set to ‘cri-RI-PMI-CQI’.

The UE could determine or identify one or more first candidate cells for CSI acquisition—from/out of all the configured/provided candidate cells (e.g., in terms/form of their candidate cell IDs/indexes e.g. provided by/in ltm-CandidateIdList) in the LTM-Config—each corresponding to/as a/the candidate cell that is configured or provided with a Reporting Setting ltm-eCSI-ReportConfig. Furthermore, the UE could determine or identify one or more second candidate cells for CSI acquisition—from/out of all the determined or identified first candidate cells for CSI acquisition—each corresponding to/as a/the first candidate cell for CSI acquisition on/in which the UE has received/applied a candidate cell TCI states activation/deactivation MAC CE for CSI acquisition (i.e., the received/applied candidate cell TCI states activation/deactivation MAC CE for CSI acquisition could be associated, specific or corresponding to a/the first candidate cell for CSI acquisition) according to or following those specified/defined herein in the present disclosure. In this case, the UE could also determine or identify one or more third candidate cells for CSI acquisition—from/out of all the determined or identified first candidate cells for CSI acquisition—other than the determined or identified second candidate cells for CSI acquisition.
In one example, the UE could only measure corresponding NZP CSI-RS resource(s) provided or configured in the NZP CSI-RS resource set(s) for CSI acquisition—defined/denoted by/as the corresponding target CSI-RS resource(s) for CSI acquisition in the present disclosure—provided by ltm-NZP-CSI-RS-ResourceSet-eCSI(s) associated with Reporting Setting(s) ltm-eCSI-ReportConfig(s) configured or provided for the second candidate cell(s) for CSI acquisition; in this case, the UE could follow setting-A and/or setting-B as specified/defined herein in the present disclosure to determine or identify the corresponding target CSI-RS resource(s) for CSI acquisition for the second candidate cell(s) for CSI acquisition.
In another example, the UE could measure corresponding NZP CSI-RS resource(s) provided or configured in the NZP CSI-RS resource set(s) for CSI acquisition—defined/denoted by/as the corresponding target CSI-RS resource(s) for CSI acquisition in the present disclosure—provided by ltm-NZP-CSI-RS-ResourceSet-eCSI(s) associated with Reporting Setting(s) ltm-eCSI-ReportConfig(s) configured or provided for the third candidate cell(s) for CSI acquisition; in this case, the UE could follow setting-A as specified/defined herein in the present disclosure to determine or identify the corresponding target CSI-RS resource(s) for CSI acquisition for the third candidate cell(s) for CSI acquisition; additionally, the UE could measure corresponding NZP CSI-RS resource(s) provided or configured in the NZP CSI-RS resource set(s) for CSI acquisition —defined/denoted by/as the corresponding target CSI-RS resource(s) for CSI acquisition in the present disclosure—provided by ltm-NZP-CSI-RS-ResourceSet-eCSI(s) associated with Reporting Setting(s) ltm-eCSI-ReportConfig(s) configured or provided for the second candidate cell(s) for CSI acquisition; in this case, the UE could follow setting-A and/or setting-B as specified/defined herein in the present disclosure to determine or identify the corresponding target CSI-RS resource(s) for CSI acquisition for the second candidate cell(s) for CSI acquisition.

According to or following those specified/defined herein in the present disclosure, the UE may not receive and/or apply any candidate cell TCI states activation/deactivation MAC CE command(s) in/on/from/for the third candidate cell(s) for CSI acquisition. The above described/specified procedure(s) could be applicable to one or more of:
before receiving and/or applying a/the LTM Cell Switch Command MAC CE that indicates a candidate cell for cell switch;
X symbol(s)/slot(s)/etc. before receiving and/or applying a/the LTM Cell Switch Command MAC CE that indicates a candidate cell for cell switch;
after receiving and/or applying a/the LTM Cell Switch Command MAC CE that indicates a candidate cell for cell switch;
X′ symbol(s)/slot(s)/etc. receiving and/or applying a/the LTM Cell Switch Command MAC CE that indicates a candidate cell for cell switch.

The UE could determine or identify value(s) of X and/or X′ according to or based on or following one or more of: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

According to or following those specified/defined herein in the present disclosure, the UE could determine or identify one or more of the candidate cells for CSI acquisition—denoted by/as target candidate cell(s) for CSI acquisition—as specified/defined herein in the present disclosure to perform actual measurement(s)/reporting(s) for actual CSI acquisition according to or based on or following one or more of.
fixed rule(s)/value(s) in system specification(s) and/or per RRC (re-)configuration; for example, the target candidate cell(s) for CSI acquisition could correspond to the candidate cell(s) for CSI acquisition on/in which the UE receives or is provided or indicated corresponding candidate cell TCI states activation/deactivation MAC CE for CSI acquisition according to or following those specified/defined herein in the present disclosure—i.e., in this case, when/if the UE does not receive any candidate cell TCI states activation/deactivation MAC CE command(s) for a candidate cell for CSI acquisition, the UE would/may not perform any actual measurement(s)/reporting(s) for actual CSI acquisition on/in/for the candidate cell for CSI acquisition (i.e., the candidate cell for CSI acquisition could not be regarded or considered or used or applied or treated as a target candidate cell for CSI acquisition); for another example, the target candidate cell(s) for CSI acquisition could correspond to all the candidate cell(s) for CSI acquisition as specified/defined herein in the present disclosure;
network's configuration(s)/indication(s) e.g. via higher layer RRC signaling(s)/parameter(s) e.g. LTM-Config and/or MAC CE command(s) and/or dynamic DCI based L1 signaling(s) according to or based on corresponding UE's capability(s) or capability signaling(s); for example, the network's configuration(s)/indication(s) could be in form of a bitmap indicating the target candidate cell(s) for CSI acquisition out of all the candidate cell(s) for CSI acquisition; for another example, the network's configuration(s)/indication(s) could be in form of a bitmap indicating the target candidate cell(s) for CSI acquisition out of all the candidate cell(s) e.g. provided by ltm-CandidateIdList;
UE's autonomous determination or selection, which could be further sent or transmitted or indicated to the network via various UL channels/signals e.g. in part of CSI/beam report(s) and/or UE's capability signaling(s).

According to or following those specified/defined herein in the present disclosure, for a candidate cell not configured with ltm-eCSI-ReportConfig, i.e., the candidate cell is not a candidate cell for CSI acquisition, the UE may not expect to perform any measurement(s)/reporting(s) for CSI acquisition in/on the candidate cell.

Before receiving an LTM Cell Switch Command MAC CE and/or before the received LTM Cell Switch Command MAC CE is applied/becomes applicable and/or no later than T_delay symbol(s)/slot(s)/etc. after the end (e.g., the last symbol/slot/etc.) of receiving/reception of the LTM Cell Switch Command MAC CE, a UE could receive from the network one or more semi-persistent (SP) CSI-RS/CSI-IM resource(s)/resource set(s) activation/deactivation MAC CE(s) for CSI acquisition.
In one example, a SP CSI-RS/CSI-IM resource(s)/resource set(s) activation/deactivation MAC CE for CSI acquisition could comprise, indicate, contain, include or provide one or more (e.g., K_{cand}≥1) candidate cells for CSI acquisition (or one or more target candidate cells for CSI acquisition)—e.g., in form of their candidate cell IDs LTM-CandidateIds (given by ltm-CandidateIdList). That is, the SP CSI-RS/CSI-IM resource(s)/resource set(s) activation/deactivation MAC CE for CSI acquisition could comprise, indicate, contain, include or provide one or more (e.g., K_{cand}≥1) x-bit fields with x=┌log₂(N_{cand})┐ wherein N_{cand} represents a/the (total) number of candidate cells or candidate cell IDs in ltm-CandidateIdList; each x-bit field could indicate a candidate cell for CSI acquisition (or a target candidate cell for CSI acquisition), and therefore, a/the ltm-NZP-CSI-RS-ResourceSet-eCSI associated with the Reporting Setting ltm-eCSI-ReportConfig configured or provided for the indicated candidate cell for CSI acquisition (or the indicated target candidate cell for CSI acquisition) as the SP NZP CSI-RS resource set for CSI acquisition, which could be activated or deactivated, for the indicated candidate cell for CSI acquisition (or the indicated target candidate cell for CSI acquisition).
In another example, a SP CSI-RS/CSI-IM resource(s)/resource set(s) activation/deactivation MAC CE for CSI acquisition could comprise, indicate, contain, include or provide one or more (e.g., K_{cand}≥1) NZP CSI-RS resource sets for CSI acquisition—e.g., in form of their NZP-CSI-RS-ResourceSet or ltm-NZP-CSI-RS-ResourceSet-eCSI indexes/IDs—each associated with or corresponding to a candidate cell for CSI acquisition (or a target candidate cell for CSI acquisition). That is, the SP CSI-RS/CSI-IM resource(s)/resource set(s) activation/deactivation MAC CE for CSI acquisition could comprise, indicate, contain, include or provide one or more (e.g., K_{cand}≥1) y-bit fields each indicating or containing an index/ID of NZP-CSI-RS-ResourceSet or ltm-NZP-CSI-RS-ResourceSet-eCSI containing Semi Persistent NZP CSI-RS resources, indicating the Semi Persistent NZP CSI-RS resource set for CSI acquisition, which could be activated or deactivated, for the associated/corresponding candidate cell for CSI acquisition (or the target candidate cell for CSI acquisition).
In another example, a SP CSI-RS/CSI-IM resource(s)/resource set(s) activation/deactivation MAC CE for CSI acquisition could comprise, indicate, contain, include or provide one or more (e.g., K_{cand}≥1) candidate cells for CSI acquisition (or one or more target candidate cells for CSI acquisition)—e.g., in form of their candidate cell IDs LTM-CandidateIds (given by ltm-CandidateIdList). That is, the SP CSI-RS/CSI-IM resource(s)/resource set(s) activation/deactivation MAC CE for CSI acquisition could comprise, indicate, contain, include or provide one or more (e.g., K_{cand}≥1) x-bit fields with x=┌log₂(N_{cand})┐ wherein N_{cand} represents a/the (total) number of candidate cells or candidate cell IDs in ltm-CandidateIdList; each x-bit field could indicate a candidate cell for CSI acquisition (or a target candidate cell for CSI acquisition). In addition, the SP CSI-RS/CSI-IM resource(s)/resource set(s) activation/deactivation MAC CE for CSI acquisition could comprise, indicate, contain, include or provide one or more (e.g., K_{cand}≥1) NZP CSI-RS resource sets for CSI acquisition—e.g., in form of their NZP-CSI-RS-ResourceSet or ltm-NZP-CSI-RS-ResourceSet-eCSI indexes/IDs—each associated with or corresponding to a (indicated) candidate cell for CSI acquisition (or a (indicated) target candidate cell for CSI acquisition). That is, the SP CSI-RS/CSI-IM resource(s)/resource set(s) activation/deactivation MAC CE for CSI acquisition could comprise, indicate, contain, include or provide one or more (e.g., K_{cand}≥1) y-bit fields each indicating or containing an index/ID of NZP-CSI-RS-ResourceSet or ltm-NZP-CSI-RS-ResourceSet-eCSI containing Semi Persistent NZP CSI-RS resources and associated, mapped, specific or corresponding to an indicated x-bit field hence an indicated candidate cell for CSI acquisition (or an indicated target candidate cell for CSI acquisition). For this example, an y-bit field could indicate the Semi Persistent NZP CSI-RS resource set for CSI acquisition, which could be activated or deactivated, for the associated/corresponding x-bit field that indicates a candidate cell for CSI acquisition (or a target candidate cell for CSI acquisition).

When/if a UE receives from the network a semi-persistent (SP) CSI-RS/CSI-IM resource(s)/resource set(s) activation/deactivation MAC CE for CSI acquisition after receiving an LTM Cell Switch Command MAC CE that indicates a candidate cell for cell switch, the UE could expect that:
the SP CSI-RS/CSI-IM resource(s)/resource set(s) activation/deactivation MAC CE for CSI acquisition could only comprise, contain, provide, indicate or include a (single) candidate cell for CSI acquisition (or a (single) target cell for CSI acquisition) and/or activate (or deactivate) a (single) Semi Persistent NZP CSI-RS resource set for CSI acquisition corresponding, associated or specific to a/the (single) candidate cell for CSI acquisition (or a/the (single) target cell for CSI acquisition)—i.e., K_{cand}=1 for/in the above described/specified examples, and/or
the aforementioned (single) candidate cell for CSI acquisition (or the (single) target cell for CSI acquisition) could correspond to or could be the same as/identical to or could have a/the same value/index/ID as the indicated candidate cell for cell switch by/in the LTM Cell Switch Command MAC CE.

Depending on the UE capability the UE may start measuring NZP CSI-RS resources—denoted by/as target NZP CSI-RS resources for CSI acquisition in the present disclosure—corresponding, specific or associated to a candidate cell for CSI acquisition (or a target candidate cell for CSI acquisition) e.g. the first transmission occasion of the corresponding NZP CSI-RS resources (hence the target NZP CSI-RS resources for CSI acquisition)
from when the UE has received the RRC configuration(s)/parameter(s) provided for (early) CSI acquisition in LTM including LTM-Config that comprises up to one Reporting Setting, ltm-eCSI-ReportConfig, for a candidate cell with each Reporting Setting ltm-eCSI-ReportConfig associated with a single ltm-NZP-CSI-RS-ResourceSet-eCSI for channel measurements, and/or when the aforementioned RRC configuration(s)/parameter(s) has been applied or become applicable, and/or
at least X symbol(s)/slot(s)/etc. from when the UE has received the RRC configuration(s)/parameter(s) provided for (early) CSI acquisition in LTM including LTM-Config that comprises up to one Reporting Setting, ltm-eCSI-ReportConfig, for a candidate cell with each Reporting Setting ltm-eCSI-ReportConfig associated with a single ltm-NZP-CSI-RS-ResourceSet-eCSI for channel measurements, and/or at least X symbol(s)/slot(s)/etc. from when the aforementioned RRC configuration(s)/parameter(s) has been applied or become applicable; herein, the UE could determine value(s) of X according to or based on or following: (i) fixed rule(s)/value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to corresponding UE's capability(s) or capability signaling(s), and/or (iii) UE's autonomous determination, selection and/or identification, which could be further indicated or transmitted or sent to the network via various UL channels/signals including CSI report(s), UE's capability signaling(s) and/or etc., and/or
from when the UE has received a SP CSI-RS/CSI-IM resource(s)/resource set(s) activation/deactivation MAC CE for CSI acquisition as specified/defined herein in the present disclosure that activates (or deactivates) the SP NZP CSI-RS resource set (hence the corresponding SP NZP CSI-RS resources) associated, corresponding or specific to the candidate cell for CSI acquisition (or the target candidate cell for CSI acquisition), and/or when the aforementioned SP CSI-RS/CSI-IM resource(s)/resource set(s) activation/deactivation MAC CE for CSI acquisition has been applied or become applicable, and/or
at least Y symbol(s)/slot(s)/etc. from when the UE has received a SP CSI-RS/CSI-IM resource(s)/resource set(s) activation/deactivation MAC CE for CSI acquisition as specified/defined herein in the present disclosure that activates (or deactivates) the SP NZP CSI-RS resource set (hence the corresponding SP NZP CSI-RS resources) associated, corresponding or specific to the candidate cell for CSI acquisition (or the target candidate cell for CSI acquisition), and/or at least Y symbol(s)/slot(s)/etc. from when the aforementioned SP CSI-RS/CSI-IM resource(s)/resource set(s) activation/deactivation MAC CE for CSI acquisition has been applied or become applicable,
   and, before receiving the LTM Cell Switch Command MAC CE [10, REF 5] and/or before the received LTM Cell Switch Command MAC CE is applied/becomes applicable and/or no later than T_delay symbol(s)/slot(s)/etc. after the end (e.g., the last symbol/slot/etc.) of receiving/reception of the LTM Cell Switch Command MAC CE.

According to or following those specified/defined herein in the present disclosure, depending on a/the corresponding UE capability(s) or capability signalling(s)
when/if a UE has received a SP CSI-RS/CSI-IM resource(s)/resource set(s) activation/deactivation MAC CE for CSI acquisition as specified/defined herein in the present disclosure that activates (or deactivates) the SP NZP CSI-RS resource set (hence the corresponding SP NZP CSI-RS resources) associated, corresponding or specific to a candidate cell for CSI acquisition (or a target candidate cell for CSI acquisition) according to or following those specified/defined herein in the present disclosure before receiving a/the LTM Cell Switch Command MAC CE indicating a candidate cell for cell switch and/or before the received LTM Cell Switch Command MAC CE is applied/becomes applicable and/or no later than T_delay symbol(s)/slot(s)/etc. after the end (e.g., the last symbol/slot/etc.) of receiving/reception of the LTM Cell Switch Command MAC CE, and/or when/if the aforementioned SP CSI-RS/CSI-IM resource(s)/resource set(s) activation/deactivation MAC CE for CSI acquisition has been applied or become applicable before receiving a/the LTM Cell Switch Command MAC CE indicating a candidate cell for cell switch and/or before the received LTM Cell Switch Command MAC CE is applied/becomes applicable and/or no later than T_delay symbol(s)/slot(s)/etc. after the end (e.g., the last symbol/slot/etc.) of receiving/reception of the LTM Cell Switch Command MAC CE
   before receiving the LTM Cell Switch Command MAC CE and/or before the received LTM Cell Switch Command MAC CE is applied/becomes applicable and/or no later than T_delay symbol(s)/slot(s)/etc. after the end (e.g., the last symbol/slot/etc.) of receiving/reception of the LTM Cell Switch Command MAC CE, the UE could measure the SP NZP CSI-RS resource set (hence the corresponding SP NZP CSI-RS resources)—that is activated (or deactivated) by/in the SP CSI-RS/CSI-IM resource(s)/resource set(s) activation/deactivation MAC CE for CSI acquisition—associated, corresponding or specific to the candidate cell for CSI acquisition (or the target candidate cell for CSI acquisition) for CSI acquisition according to or following those specified/defined herein in the present disclosure
   after receiving a/the LTM Cell Switch Command MAC CE and/or after the received LTM Cell Switch Command MAC CE is applied/becomes applicable and/or no earlier than/after T_proc symbol(s)/slot(s)/etc. after the end (e.g., the last symbol/slot/etc.) of receiving/reception of the LTM Cell Switch Command MAC CE,
      when/if the candidate cell for CSI acquisition (or the target candidate cell for CSI acquisition) that is associated, corresponding or specific to the activated (or deactivated) NZP CSI-RS resource set (hence the corresponding SP NZP CSI-RS resources) indicated or provided by/in the SP CSI-RS/CSI-IM resource(s)/resource set(s) activation/deactivation MAC CE for CSI acquisition according to or based on or following those specified/defined herein in the present disclosure is the same as or identical to (e.g., having the same candidate cell ID/index value) the candidate cell for cell switch provided or indicated by the LTM Cell Switch Command MAC CE, the UE could continue measuring the SP NZP CSI-RS resource set (hence the corresponding SP NZP CSI-RS resources)—that is activated (or deactivated) by/in the SP CSI-RS/CSI-IM resource(s)/resource set(s) activation/deactivation MAC CE for CSI acquisition—associated, corresponding or specific to the candidate cell for CSI acquisition (or the target candidate cell for CSI acquisition)—or equivalently the candidate cell for cell switch—for CSI acquisition according to or following those specified/defined herein in the present disclosure,
      otherwise, i.e., when/if the candidate cell for CSI acquisition (or the target candidate cell for CSI acquisition) that is associated, corresponding or specific to the activated (or deactivated) NZP CSI-RS resource set (hence the corresponding SP NZP CSI-RS resources) indicated or provided by/in the SP CSI-RS/CSI-IM resource(s)/resource set(s) activation/deactivation MAC CE for CSI acquisition according to or based on or following those specified/defined herein in the present disclosure is different from (e.g., having a different candidate cell ID/index value) the candidate cell for cell switch provided or indicated by the LTM Cell Switch Command MAC CE, the UE may not measure the SP NZP CSI-RS resource set (hence the corresponding SP NZP CSI-RS resources)—that is activated (or deactivated) by/in the SP CSI-RS/CSI-IM resource(s)/resource set(s) activation/deactivation MAC CE for CSI acquisition—associated, corresponding or specific to the candidate cell for CSI acquisition (or the target candidate cell for CSI acquisition) for CSI acquisition,
when/if a UE has received a SP CSI-RS/CSI-IM resource(s)/resource set(s) activation/deactivation MAC CE for CSI acquisition as specified/defined herein in the present disclosure that activates (or deactivates) the SP NZP CSI-RS resource set (hence the corresponding SP NZP CSI-RS resources) associated, corresponding or specific to a candidate cell for CSI acquisition (or a target candidate cell for CSI acquisition) according to or following those specified/defined herein in the present disclosure after receiving a/the LTM Cell Switch Command MAC CE indicating a candidate cell for cell switch and/or after the received LTM Cell Switch Command MAC CE is applied/becomes applicable and/or no earlier than/after T_proc symbol(s)/slot(s)/etc. after the end (e.g., the last symbol/slot/etc.) of receiving/reception of the LTM Cell Switch Command MAC CE, and/or when/if the aforementioned SP CSI-RS/CSI-IM resource(s)/resource set(s) activation/deactivation MAC CE for CSI acquisition has been applied or become applicable after receiving a/the LTM Cell Switch Command MAC CE indicating a candidate cell for cell switch and/or after the received LTM Cell Switch Command MAC CE is applied/becomes applicable and/or no earlier than/after T_proc symbol(s)/slot(s)/etc. after the end (e.g., the last symbol/slot/etc.) of receiving/reception of the LTM Cell Switch Command MAC CE
   for K_{cand}=1, i.e., a (single) candidate cell for CSI acquisition (or a (single) target candidate cell for CSI acquisition) is indicated or provided and/or a (single) Semi Persistent NZP CSI-RS resource set for CSI acquisition corresponding, associated or specific to a/the (single) candidate cell for CSI acquisition (or a/the (single) target cell for CSI acquisition) is activated (or deactivated) by/in the SP CSI-RS/CSI-IM resource(s)/resource set(s) activation/deactivation MAC CE for CSI acquisition wherein the UE could expect or assume that the (single) candidate cell for CSI acquisition (or the target candidate cell for CSI acquisition) is the same as or identical to the candidate cell for cell switch indicated/provided in/by the LTM Cell Switch Command MAC CE according to or following those specified/defined herein in the present disclosure, the UE could start measuring the SP NZP CSI-RS resource set (hence the corresponding SP NZP CSI-RS resources)—that is activated (or deactivated) by/in the SP CSI-RS/CSI-IM resource(s)/resource set(s) activation/deactivation MAC CE for CSI acquisition—associated, corresponding or specific to the candidate cell for CSI acquisition (or the target candidate cell for CSI acquisition)—or equivalently the candidate cell for cell switch—for CSI acquisition from the most recent or latest (in time) of:
      when the LTM Cell Switch Command MAC CE is received
      when the LTM Cell Switch Command MAC CE is applied
      X symbol(s)/slot(s)/etc. after the LTM Cell Switch Command MAC CE is received
      X symbol(s)/slot(s)/etc. after the LTM Cell Switch Command MAC CE is applied
      when the SP CSI-RS/CSI-IM resource(s)/resource set(s) activation/deactivation MAC CE for CSI acquisition is received
      when the SP CSI-RS/CSI-IM resource(s)/resource set(s) activation/deactivation MAC CE for CSI acquisition is applied
      Y symbol(s)/slot(s)/etc. after the SP CSI-RS/CSI-IM resource(s)/resource set(s) activation/deactivation MAC CE for CSI acquisition is received
      Y symbol(s)/slot(s)/etc. after the SP CSI-RS/CSI-IM resource(s)/resource set(s) activation/deactivation MAC CE for CSI acquisition is applied
   for K_{cand}≥1, i.e., multiple candidate cells for CSI acquisition (or multiple target candidate cells for CSI acquisition) are indicated or provided and/or multiple Semi Persistent NZP CSI-RS resource sets for CSI acquisition each corresponding, associated or specific to one of the K_{cand} candidate cells for CSI acquisition (or one of the K_{cand} candidate cells for CSI acquisition) are activated (or deactivated) by/in the SP CSI-RS/CSI-IM resource(s)/resource set(s) activation/deactivation MAC CE for CSI acquisition,
      when/if one of the aforementioned K_{cand} candidate cells for CSI acquisition (or one of the K_{cand} target candidate cells for CSI acquisition) is the same as or identical to (e.g., having a/the same candidate cell ID/index value) the candidate cell for cell switch provided or indicated by/in the LTM Cell Switch Command MAC CE, the UE could start measuring the SP NZP CSI-RS resource set (hence the corresponding SP NZP CSI-RS resources)—that is activated (or deactivated) by/in the SP CSI-RS/CSI-IM resource(s)/resource set(s) activation/deactivation MAC CE for CSI acquisition—associated, corresponding or specific to the candidate cell for cell switch—for CSI acquisition from the most recent or latest (in time) of:
         when the LTM Cell Switch Command MAC CE is received
         when the LTM Cell Switch Command MAC CE is applied
         X symbol(s)/slot(s)/etc. after the LTM Cell Switch Command MAC CE is received
         X symbol(s)/slot(s)/etc. after the LTM Cell Switch Command MAC CE is applied
         when the SP CSI-RS/CSI-IM resource(s)/resource set(s) activation/deactivation MAC CE for CSI acquisition is received
         when the SP CSI-RS/CSI-IM resource(s)/resource set(s) activation/deactivation MAC CE for CSI acquisition is applied
         Y symbol(s)/slot(s)/etc. after the SP CSI-RS/CSI-IM resource(s)/resource set(s) activation/deactivation MAC CE for CSI acquisition is received
         Y symbol(s)/slot(s)/etc. after the SP CSI-RS/CSI-IM resource(s)/resource set(s) activation/deactivation MAC CE for CSI acquisition is applied
      and, the UE would/may not measure any (SP) CSI-RS resource(s) associated, specific or corresponding to candidate cell(s) for CSI acquisition (or target candidate cell(s) for CSI acquisition) that is different from or other than (e.g., having different candidate cell ID/index value(s)) the candidate cell for cell switch;
      otherwise, i.e., when/if all the aforementioned K_{cand} candidate cells for CSI acquisition (or all the K_{cand} target candidate cells for CSI acquisition) are different from or other than (e.g., having different candidate cell ID/index values) the candidate cell for cell switch provided or indicated by/in the LTM Cell Switch Command MAC CE, the UE would/may not measure any (SP) CSI-RS resource(s) associated, specific or corresponding to any of the aforementioned K_{cand} candidate cells for CSI acquisition (or any of the K_{cand} target candidate cells for CSI acquisition).

The UE could determine or identify value(s) of X and/or Y according to or based on or following one or more of: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

A UE is not expected to be configured with an aperiodic CSI trigger state containing more than N_{CPU} Reporting Settings. Processing of a CSI report occupies a number of CPUs for a number of symbols as follows:
O_{CPU}=0 for a CSI report with CSI-ReportConfig with higher layer parameter reportQuantity set to ‘none’ and CSI-RS-ResourceSet with higher layer parameter trs-Info configured O_{CPU}=1 for a CSI report with LTM-CSI-ReportConfig or a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured)
O_{CPU}=(Y+1)·X, for a CSI report with CSI-ReportConfig with higher layer parameter reportQuantity set to ‘tdcp’ and with number of delays Y configured by higher layer parameter Y, where the value of X∈{1, 2} is reported by UE capability.
for a CSI report with CSI-ReportConfig with higher layer parameter reportQuantity set to ‘cri-RI-PMI-CQI’, ‘cri-RI-i1’, ‘cri-RI-i1-CQI’, ‘cri-RI-CQI’, or ‘cri-RI-LI-PMI-CQI’,
   if max{μ_{PDCCH}, μ_{CSI-RS}, μ_{UL}}≤3, and if a CSI report is aperiodically triggered without transmitting a PUSCH with either transport block or HARQ-ACK or both when L=0 CPUs are occupied, where the CSI corresponds to a single CSI with wideband frequency-granularity and to at most 4 CSI-RS ports in a single resource without CRI report and where codebookType is set to ‘typeI-SinglePanel’ or where reportQuantity is set to ‘cri-RI-CQI’, O_{CPU}=N_{CPU},
   if a CSI-ReportConfig is configured with codebookType set to ‘typeI-SinglePanel’ and the corresponding CSI-RS Resource Set for channel measurement is configured with two Resource Groups and N Resource Pairs, O_{CPU}=X·N+M, where X is the number of CPUs occupied by a pair of CMRs subject to mTRP-CSI-numCPU-r17 and M is defined in clause 5.2.1.4.2,
   if a CSI-ReportConfig contains a list of L sub-configurations provided by the higher layer parameter csi-ReportSubConfigToAddModList,

$${O}_{CPU} = {\sum }_{i = 1}^{L} {K}_{s}^{i}$$

for periodic CSI reporting, where

$${K}_{s}^{i}$$

is the total number of CSI-RS resources corresponding to the i-th sub-configuration.

$${O}_{CPU} = {\sum }_{i = 1}^{L} {K}_{s}^{i}$$

for aperiodic and semi-persistent CSI reporting, where

$${K}_{s}^{i}$$

is the total number of CSI-RS resources corresponding to the i-th sub-configuration, and where the i-th sub-configuration is from N indicated sub-configurations out of L sub-configurations contained in a CSI-ReportConfig, where N≤L and N≥1.
if a CSI-ReportConfig is configured with the higher layer parameter reportQuantity set to ‘cri-RI-PMI-CQI’, codebookType set to ‘typeII-CJT-r18’ or ‘typeII-CJT-PortSelection-r18’ and the corresponding NZP-CSI-RS-ResourceSet for channel measurement is configured with 1<N_{TRP}≤4 resources, O_{CPU}=ceil(X·N_{TRP}), where X∈{1, 1.5, 2} is reported by UE capability indication,
if a CSI-ReportConfig is configured with the higher layer parameter reportQuantity set to ‘cri-RI-PMI-CQI’ and with codebookType set to ‘typeII-Doppler-r18’ or ‘typeII-Doppler-PortSelection-r18’,
   if the corresponding CSI-RS Resource Set for channel measurement is aperiodic and configured with K CSI-RS resources, O_{CPU}=8 for K=12 and O_{CPU}=Y₁·K for K<12, where Y₁∈{1, 2, 3} is reported by UE capability indication,
   if the corresponding CSI-RS Resource Set for channel measurement is periodic or semi-persistent and configured with a single CSI-RS resource, O_{CPU}=4 for N₄=1 and O_{CPU}=max(Y₂·N₄, 4) for N₄>1, where the value of N₄ is configured by the higher layer parameter N4, and Y₂∈{1, 2, 3} is reported by UE capability indication,
otherwise, O_{CPU}=Kₛ, where Kₛ is the number of CSI-RS resources in the CSI-RS resource set for channel measurement.

For a CSI report with CSI-ReportConfig with higher layer parameter reportQuantity not set to ‘none’, or a CSI report with LTM-CSI-ReportConfig, the CPU(s) are occupied for a number of OFDM symbols as follows:
A periodic or semi-persistent CSI report (excluding an initial semi-persistent CSI report on PUSCH after the PDCCH triggering the report and a semi-persistent CSI report on PUSCH configured with the higher layer parameter codebookType set to ‘typeII-Doppler-r18’ or ‘typeII-Doppler-PortSelection-r18’) occupies CPU(s) from the first symbol of the earliest one of each CSI-RS/CS-IM/SSB resource, or each CSI-RS/CSI-IM resource associated with all configured sub-configurations for periodic CSI report corresponding to a CSI-ReportConfig that contains a list of sub-configurations provided by csi-ReportSubConfigToAddModList, or each CSI-RS/CSI-IM resource associated with all activated/triggered sub-configurations for semi-persistent CSI report corresponding to a CSI-ReportConfig that contains a list of sub-configurations provided by csi-ReportSubConfigToAddModList, for channel or interference measurement, respective latest CSI-RS/CSI-IM/SSB occasion no later than the corresponding CSI reference resource, until the last symbol of the configured PUSCH/PUCCH carrying the report.
An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of [6, REF 3], for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in clause 10.1 of [6, REF 3], for the purpose of determining the CPU occupation duration, the PDCCH candidate that ends later in time is used.
A semi-persistent CSI report on PUSCH configured with the higher layer parameter codebookType set to ‘typeII-Doppler-r18’ or ‘typeII-Doppler-PortSelection-r18’ occupies CPU(s) from the first symbol of K_{P}-th latest consecutive periodic/semi-persistent CSI-RS occasions no later than CSI reference resource, until the last symbol of the PUSCH carrying the report, where the value of K_{P}∈{1,2,4} is indicated by UE capability.

CSI reports are associated with a priority value Pri_{iCSI}(y, k, c, s)=2·N_{cells}·Mₛ·y+N_{cells}·Mₛ·k+Mₛ·c+s where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
for a CSI report configured with ltm-eCSI-ReportConfig. (i) in one example, y=0 for the CSI report to be carried on PUSCH, (ii) in another example, y=1 for the CSI report to be carried on PUSCH, and (iii) in another example, y=0 if the CSI report is to be carried on DG PUSCH or PUSCH based on UL grant (e.g., Msg3 PUSCH in RACH procedure for RACH-based LTM), or y=1 if the CSI report is to be carried on CG PUSCH (e.g., a/the first UL transmission that carries RRC completion message for RACH-less and/or RACH-based LTM);
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
for a CSI report configured with LTM-CSI-ReportConfig, c is the serving cell index value where the report configuration is configured;
s is the reportConfigID and Ms is the value of the higher layer parameter maxNrofCSI-ReportConfigurations;
for a CSI report configured with LTM-CSI-ReportConfig, s is the LTM-CSI-ReportConfigID and Ms is the value of the higher layer parameter maxNrofLTM-CSI-ReportConfigurations.

A CSI report configured with LTM-CSI-ReportConfig or ltm-eCSI-ReportConfig has a higher priority over all CSI report(s) configured with CSI-ReportConfig irrespective of Pri_{iCSI}(y, k, c, s) value in case of collision with CSI report(s) configured with CSI-ReportConfig. Alternatively, a CSI report configured with LTM-CSI-ReportConfig has a higher priority over a CSI report configured with ltm-eCSI-ReportConfig. Optionally, a CSI report configured with ltm-eCSI-ReportConfig has a higher priority over a CSI report configured with LTM-CSI-ReportConfig.

For a periodic CSI-RS resource in an NZP-CSI-RS-ResourceSet or an ltm-CSI-NZP-CSI-RS-ResourceSet provided for L1 (e.g., L1-RSRP) measurement(s)/reporting(s) for LTM or an ltm-NZP-CSI-RS-ResourceSet-eCSI provided for CSI acquisition for LTM configured with higher layer parameter trs-Info, the UE could expect that a TCI-State or a CandidateTCI-State indicates one of the following quasi co-location type(s):
‘typeC’ with an SS/PBCH block and, when applicable, ‘typeD’ with the same SS/PBCH block where SS/PBCH block may have a PCI different from the PCI of the serving cell. The UE can assume center frequency, SCS, SFN offset are the same for SS/PBCH block from the serving cell and SS/PBCH block having a PCI different from the serving cell, or
typeC’ with an SS/PBCH block and, when applicable, ‘typeD’ with a CSI-RS resource in an NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter repetition, where SS/PBCH block may have a PCI different from the PCI of the serving cell. The UE can assume center frequency, SCS, SFN offset are the same for SS/PBCH block from the serving cell and SS/PBCH block having a PCI different from the serving cell.

For periodic/semi-persistent CSI-RS, if the UE is configured with dl-OrJointTCI-StateList and/or ltm-DL-OrJointTCI-StateToAddModList, the UE can assume that the indicated TCI-State, or the CandidateTCI-State indicated in/by the LTM Cell Switch Command MAC CE (if any/applicable), is not applied.

For an aperiodic CSI-RS resource in an NZP-CSI-RS-ResourceSet or an ltm-CSI-NZP-CSI-RS-ResourceSet provided for L1 (e.g., L1-RSRP) measurement(s)/reporting(s) for LTM or an ltm-NZP-CSI-RS-ResourceSet-eCSI provided for CSI acquisition for LTM configured with higher layer parameter trs-Info, the UE could expect that a TCI-State or a CandidateTCI-State indicates qcl-Type set to ‘typeA’ with a periodic CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter trs-Info and, when applicable, qcl-Type set to ‘typeD’ with the same periodic CSI-RS resource.

For a CSI-RS resource in an NZP-CSI-RS-ResourceSet or an ltm-CSI-NZP-CSI-RS-ResourceSet provided for L1 (e.g., L1-RSRP) measurement(s)/reporting(s) for LTM or an ltm-NZP-CSI-RS-ResourceSet-eCSI provided for CSI acquisition for LTM configured without higher layer parameter trs-Info and without the higher layer parameter repetition, the UE could expect that a TCI-State or a CandidateTCI-State indicates one of the following quasi co-location type(s):
‘typeA’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter trs-Info and, when applicable, ‘typeD’ with the same CSI-RS resource, or
‘typeA’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter trs-Info and, when applicable, ‘typeD’ with an SS/PBCH block, where SS/PBCH block may have a PCI different from the PCI of the serving cell. The UE can assume center frequency, SCS, SFN offset are the same for SS/PBCH block from the serving cell and SS/PBCH block having a PCI different from the serving cell, or
‘typeA’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter trs-Info and, when applicable, ‘typeD’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter repetition, or
‘typeB’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter trs-Info when ‘typeD’ is not applicable.

For a CSI-RS resource in an NZP-CSI-RS-ResourceSet or an ltm-CSI-NZP-CSI-RS-ResourceSet provided for L1 (e.g., L1-RSRP) measurement(s)/reporting(s) for LTM or an ltm-NZP-CSI-RS-ResourceSet-eCSI provided for CSI acquisition for LTM configured with higher layer parameter repetition, the UE could expect that a TCI-State or a CandidateTCI-State indicates one of the following quasi co-location type(s):
‘typeA’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter trs-Info and, when applicable, ‘typeD’ with the same CSI-RS resource, or
‘typeA’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter trs-Info and, when applicable, ‘typeD’ with a CSI-RS resource in a NZP-CSI-RS-ResourceSet or an ltm-CSI-NZP-CSI-RS-ResourceSet or an ltm-NZP-CSI-RS-ResourceSet-eCSI as specified/defined herein in the present disclosure configured with higher layer parameter repetition, or
‘typeC’ with an SS/PBCH block and, when applicable, ‘typeD’ with the same SS/PBCH block, the reference RS may additionally be an SS/PBCH block having a PCI different from the PCI of the serving cell. The UE can assume center frequency, SCS, SFN offset are the same for SS/PBCH block from the serving cell and SS/PBCH block having a PCI different from the serving cell.

In one embodiment, if a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in clause 13 of REF 3, and the UE is provided a C-RNTI, the UE monitors PDCCH candidates only at monitoring occasions associated with a SS/PBCH block, where the SS/PBCH block is determined by the most recent of
indication/application of one or more TCI states or one or more indicated/applied TCI states (the one or more TCI states could correspond to or could be those indicated/applied the last or the latest in time among all the (indicated/applied) TCI state(s) as specified/defined herein in the present disclosure) each including a CSI-RS which is quasi-co-located with the SS/PBCH block, or when the one or more TCI states are/have been indicated/applied (or have become applicable) with each of the one or more TCI states including a CSI-RS which is quasi-co-located with the SS/PBCH block, wherein the UE could determine or identify the one or more (indicated/applied) TCI states used for (or applied to) a/the CORESET with index 0 according to or based on or following
   when/if the UE is provided dl-OrJointTCI-StateList and follow UnifiedTCI-State for a CORESET with index 0, as described in [6, REF 4], the (indicated/applied) TCI state(s) could be indicated by/via a TCI codepoint in a unified TCI state(s) activation/deactivation MAC CE command or of a TCI field in a beam indication DCI of format 1_1/1_2 with or without DL assignment, and/or
   when/if the UE is provided dl-OrJointTCI-StateList, and is indicated a first TCI-State and a second TCI-State and applyIndicatedTCI-State for a/the CORESET with index 0, and/or when/if applyIndicatedTCI-State=‘first’, ‘second’ or ‘both’, as described in [6, REF 4], the (indicated/applied) TCI state(s) could be indicated by/via a TCI codepoint in an enhanced unified TCI state(s) activation/deactivation MAC CE command or of a TCI field in a beam indication DCI of format 1_1/1_2 with or without DL assignment, and/or
   otherwise, or else, the (indicated/applied) TCI state(s) could be indicated by/via a MAC CE activation command for a/the CORESET with index 0, if any (or a MAC CE activation command indicating the (indicated/applied) TCI state(s) of the active BWP includes a/the CORESET with index 0, as described in [6, REF 4], if any), and/or
   otherwise, or else, when/if the UE is provided ltm-DL-OrJointTCI-StateToAddModList, the (indicated/applied) TCI state(s) provided by CandidateTCI-State(s), could be indicated by an LTM Cell Switch Command MAC CE that triggers a RACH-less or RACH-based LTM cell switch, if any, or
a random access procedure that is not initiated by a PDCCH order that triggers a contention-free random access procedure (if no MAC CE activation command, e.g., the MAC CE activation command for the CORESET with index 0 or the LTM Cell Switch Command MAC CE, indicating a TCI state for the CORESET is received after the most recent random access procedure), or
configured-grant based PUSCH transmission in RRC_INACTIVE state as described in clause 19.1 of REF 3.

In one embodiment, if a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in clause 13 of REF 3, and the UE is provided a C-RNTI, the UE monitors PDCCH candidates only at monitoring occasions associated with a SS/PBCH block, where the SS/PBCH block is determined according to or based on or following:
if the UE is provided dl-OrJointTCI-StateList and followUnifiedTCI-State for a CORE SET with index 0, as described in [6, REF 4], one or more indicated/applied TCI states (the one or more TCI states could correspond to or could be those indicated/applied the last or the latest in time among all the (indicated/applied) TCI state(s) as specified/defined herein in the present disclosure) used for (or applied to) a/the CORESET with index 0 each including a CSI-RS which is quasi-co-located with the SS/PBCH block by/via a TCI codepoint in a unified TCI state(s) activation/deactivation MAC CE command or of a TCI field in a beam indication DCI of format 1_1/1_2 with or without DL assignment,
else if the UE is provided dl-OrJointTCI-StateList, and is indicated a first TCI-State and a second TCI-State and applyIndicatedTCI-State for a/the CORESET with index 0, and/or when/if applyIndicatedTCI-State=‘first’, ‘second’ or ‘both’, as described in [6, REF 4], one or more indicated/applied TCI states (the one or more TCI states could correspond to or could be those indicated/applied the last or the latest in time among all the (indicated/applied) TCI state(s) as specified/defined herein in the present disclosure) used for (or applied to) a/the CORESET with index 0 each including a CSI-RS which is quasi-co-located with the SS/PBCH block by/via a TCI codepoint in an enhanced unified TCI state(s) activation/deactivation MAC CE command or of a TCI field in a beam indication DCI of format 1_1/1_2 with or without DL assignment,
else, by the most recent of
   indication/application of one or more TCI states or one or more indicated/applied TCI states (the one or more TCI states could correspond to or could be those indicated/applied the last or the latest in time among all the (indicated/applied) TCI state(s) as specified/defined herein in the present disclosure) each including a CSI-RS which is quasi-co-located with the SS/PBCH block, or when the one or more TCI states are/have been indicated/applied (or have become applicable) with each of the one or more TCI states including a CSI-RS which is quasi-co-located with the SS/PBCH block, wherein the UE could determine or identify the one or more (indicated/applied) TCI states used for (or applied to) a/the CORESET with index 0 according to or based on or following
      the (indicated/applied) TCI state(s) could be indicated by/via a MAC CE activation command for a/the CORESET with index 0, if any (or a MAC CE activation command indicating the (indicated/applied) TCI state(s) of the active BWP includes a/the CORESET with index 0, as described in [6, REF 4], if any), and/or
      when/if the UE is provided ltm-DL-OrJointTCI-StateToAddModList, the (indicated/applied) TCI state(s) provided by CandidateTCI-State(s), could be indicated by an LTM Cell Switch Command MAC CE that triggers a RACH-less or RACH-based LTM cell switch, if any, or
   a random access procedure that is not initiated by a PDCCH order that triggers a contention-free random access procedure (if no MAC CE activation command, e.g., the MAC CE activation command for the CORESET with index 0 or the LTM Cell Switch Command MAC CE, indicating a TCI state for the CORESET is received after the most recent random access procedure), or
   configured-grant based PUSCH transmission in RRC_INACTIVE state as described in clause 19.1 of REF 3.

In one embodiment, if a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in clause 13 of REF 3, and the UE is provided a C-RNTI, the UE monitors PDCCH candidates only at monitoring occasions associated with a SS/PBCH block, where the SS/PBCH block is determined according to one or more indicated/applied TCI states (the one or more TCI states could correspond to or could be those indicated/applied the last or the latest in time among all the (indicated/applied) TCI state(s) as specified/defined herein in the present disclosure) each including a CSI-RS which is quasi-co-located with the SS/PBCH block, wherein the UE could determine or identify the one or more (indicated/applied) TCI states used for (or applied to) a/the CORESET with index 0 according to or based on or following:
when/if the UE is provided dl-OrJointTCI-StateList and followUnifiedTCI-State for a CORESET with index 0, as described in [6, REF 4], the (indicated/applied) TCI state(s) could be indicated by/via a TCI codepoint in a unified TCI state(s) activation/deactivation MAC CE command or of a TCI field in a beam indication DCI of format 1_1/1_2 with or without DL assignment, and/or
when/if the UE is provided dl-OrJointTCI-StateList, and is indicated a first TCI-State and a second TCI-State and applyIndicatedTCI-State for a/the CORESET with index 0, and/or when/if applyIndicatedTCI-State=‘first’, ‘second’ or ‘both’, as described in [6, REF 4], the (indicated/applied) TCI state(s) could be indicated by/via a TCI codepoint in an enhanced unified TCI state(s) activation/deactivation MAC CE command or of a TCI field in a beam indication DCI of format 1_1/1_2 with or without DL assignment, and/or
otherwise, or else, by the most recent of
   indication/application of one or more TCI states or one or more indicated/applied TCI states (the one or more TCI states could correspond to or could be those indicated/applied the last or the latest in time among all the (indicated/applied) TCI state(s) as specified/defined herein in the present disclosure) each including a CSI-RS which is quasi-co-located with the SS/PBCH block, or when the one or more TCI states are/have been indicated/applied (or have become applicable) with each of the one or more TCI states including a CSI-RS which is quasi-co-located with the SS/PBCH block, wherein the UE could determine or identify the one or more (indicated/applied) TCI states used for (or applied to) a/the CORESET with index 0 according to or based on or following
      the (indicated/applied) TCI state(s) could be indicated by/via a MAC CE activation command for a/the CORESET with index 0, if any (or a MAC CE activation command indicating the (indicated/applied) TCI state(s) of the active BWP includes a/the CORESET with index 0, as described in [6, REF 4], if any), and/or
      when/if the UE is provided ltm-DL-OrJointTCI-StateToAddModList, the (indicated/applied) TCI state(s) provided by CandidateTCI-State(s), could be indicated by an LTM Cell Switch Command MAC CE that triggers a RACH-less or RACH-based LTM cell switch, if any, or
   a random access procedure that is not initiated by a PDCCH order that triggers a contention-free random access procedure (if no MAC CE activation command, e.g., the MAC CE activation command for the CORESET with index 0 or the LTM Cell Switch Command MAC CE, indicating a TCI state for the CORESET is received after the most recent random access procedure), or
   configured-grant based PUSCH transmission in RRC_INACTIVE state as described in clause 19.1 of REF 3.

In one embodiment, if a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in clause 13 of REF 3, and the UE is provided a C-RNTI, the UE monitors PDCCH candidates only at monitoring occasions associated with a SS/PBCH block, where the SS/PBCH block is determined according to or based on or following:
if the UE is provided dl-OrJointTCI-StateList and followUnifiedTCI-State for a CORE SET with index 0, as described in [6, REF 4], one or more indicated/applied TCI states (the one or more TCI states could correspond to or could be those indicated/applied the last or the latest in time among all the (indicated/applied) TCI state(s) as specified/defined herein in the present disclosure) used for (or applied to) a/the CORESET with index 0 each including a CSI-RS which is quasi-co-located with the SS/PBCH block by/via a TCI codepoint in a unified TCI state(s) activation/deactivation MAC CE command or of a TCI field in a beam indication DCI of format 1_1/1_2 with or without DL assignment,
else if the UE is provided dl-OrJointTCI-StateList, and is indicated a first TCI-State and a second TCI-State and applyIndicatedTCI-State for a/the CORESET with index 0,
   when/if applyIndicatedTCI-State=‘first’, ‘second’ or ‘both’, one or more indicated/applied TCI states (the one or more TCI states could correspond to or could be those indicated/applied the last or the latest in time among all the (indicated/applied) TCI state(s) as specified/defined herein in the present disclosure) used for (or applied to) a/the CORESET with index 0 each including a CSI-RS which is quasi-co-located with the SS/PBCH block by/via a TCI codepoint in an enhanced unified TCI state(s) activation/deactivation MAC CE command or of a TCI field in a beam indication DCI of format 1_1/1_2 with or without DL assignment,
   otherwise/else, e.g., when/if applyIndicatedTCI-State=‘none’, one or more indicated/applied TCI states used for (or applied to) a/the CORESET with index 0 indicated by/via a MAC CE activation command for a/the CORESET with index 0, if any (or a MAC CE activation command indicating the TCI state(s) of the active BWP includes a/the CORESET with index 0, as described in [6, REF 4], if any)
else, by the most recent of
   indication/application of one or more TCI states or one or more indicated/applied TCI states (the one or more TCI states could correspond to or could be those indicated/applied the last or the latest in time among all the (indicated/applied) TCI state(s) as specified/defined herein in the present disclosure) each including a CSI-RS which is quasi-co-located with the SS/PBCH block, or when the one or more TCI states are/have been indicated/applied (or have become applicable) with each of the one or more TCI states including a CSI-RS which is quasi-co-located with the SS/PBCH block, wherein the UE could determine or identify the one or more (indicated/applied) TCI states used for (or applied to) a/the CORESET with index 0 according to or based on or following
      the (indicated/applied) TCI state(s) could be indicated by/via a MAC CE activation command for a/the CORESET with index 0, if any (or a MAC CE activation command indicating the (indicated/applied) TCI state(s) of the active BWP includes a/the CORESET with index 0, as described in [6, REF 4], if any), and/or
      when/if the UE is provided ltm-DL-OrJointTCI-StateToAddModList, the (indicated/applied) TCI state(s) provided by CandidateTCI-State(s), could be indicated by an LTM Cell Switch Command MAC CE that triggers a RACH-less or RACH-based LTM cell switch, if any, or
   a random access procedure that is not initiated by a PDCCH order that triggers a contention-free random access procedure (if no MAC CE activation command, e.g., the MAC CE activation command for the CORESET with index 0 or the LTM Cell Switch Command MAC CE, indicating a TCI state for the CORESET is received after the most recent random access procedure), or
   configured-grant based PUSCH transmission in RRC_INACTIVE state as described in clause 19.1 of REF 3.

In one embodiment, a UE configured with LTM-Config can be provided configurations for CSI acquisition, by up to one Reporting Setting, ltm-CSI-ReportConfig, for a candidate cell. Each Reporting Setting ltm-CSI-ReportConfig is associated with either one or two Resource Settings
When one Resource Setting (given by higher layer parameter ltm-ResourcesForChannelMeasurement) is configured, it provides a list of NZP CSI-RS resources for both channel and interference measurements. The UE is not expected to be configured with more than 128 NZP CSI-RS ports in the CSI-RS resource set contained within the Resource Setting.
When two Resource Settings are configured, the first Resource Setting (given by higher layer parameter ltm-ResourcesForChannelMeasurement) provides a list of NZP CSI-RS resources for channel measurement, and the second Resource Setting (given by higher layer parameter ltm-ResourceForInterferenceMeasurements), provides a list of CSI-IM resources for interference measurement. The UE is not expected to be configured with more than 128 NZP CSI-RS ports in the CSI-RS resource set contained within the Resource Setting.

For example (when/if one Resource Setting is configured according to or following those specified/defined herein in the present disclosure), the Resource Setting given by higher layer parameter ltm-ResourcesForChannelMeasurement, LTM-CSI-ResourceConfig, contains configuration of a ltm-NZP-CSI-RS-ResourceSet which comprises of a list of Z≥1 NZP CSI-RS resource indices (given by ltm-CSI-RS-ResourceList) e.g. corresponding to a list of Z NZP CSI-RS resources for both channel and interference measurements and a list of Z LTM-CandidateIds (given by ltm-CandidateIdList) referring to candidate cells associated with the NZP CSI-RS resource indices. For CSI acquisition associated with a Reporting Setting, ltm-CSI-ReportConfig, the UE is expected to measure the NZP-CSI-RS resources in ltm-CSI-RS-ResourceList associated with the LTM-CandidateId that is equal to the LTM-CandidateId of the LTM-Candidate under which the Reporting Setting is configured.

| | |
|---|---|
| LTM-CSI-IM-ResourceSet-r19 ::= | SEQUENCE { |
| ltm-CSI-IM-ResourceList-r19 | SEQUENCE (SIZE (1..maxNrofLTM-CSI-IM- |

ResourcesPerSet-R19)) OF CSI-IM-ResourceId,

| | |
|---|---|
| ltm-CandidateIdList-r19 | SEQUENCE (SIZE (1..maxNrofLTM-CSI-IM- |

ResourcesPerSet-r18)) OF LTM-CandidateId-r18,
...
}
or

| | |
|---|---|
| LTM-CSI-IM-ResourceSet-r19 ::= | SEQUENCE { |
| ltm-CSI-IM-ResourceSetId-r19 | CSI-IM-ResourceSetId, |
| ltm-CandidateIdList-r19 | SEQUENCE (SIZE (1..maxNrofLTM-CSI- |

ResourcesPerSet-r18)) OF LTM-CandidateId-r18,
...
}

For another example (when/if one Resource Setting is configured according to or following those specified/defined herein in the present disclosure),
the first Resource Setting given by higher layer parameter ltm-ResourcesForChannelMeasurement, LTM-CSI-ResourceConfig, contains configuration of a ltm-NZP-CSI-RS-ResourceSet which comprises of a list of Z≥1 NZP CSI-RS resource indices (given by ltm-CSI-RS-ResourceList) e.g. corresponding to a list of Z NZP CSI-RS resources for channel measurement(s) and a list of Z LTM-CandidateIds (given by ltm-CandidateIdList) referring to candidate cells associated with the NZP CSI-RS resource indices. For CSI acquisition associated with a Reporting Setting, ltm-CSI-ReportConfig, the UE is expected to measure the NZP-CSI-RS resources in ltm-CSI-RS-ResourceList associated with the LTM-CandidateId that is equal to the LTM-CandidateId of the LTM-Candidate under which the Reporting Setting is configured;
the second Resource Setting given by higher layer parameter ltm-ResourcesForInterferenceMeasurement, LTM-CSI-ResourceConfig, contains configuration of a ltm-CSI-IM-ResourceSet which comprises of a list of Z≥1 CSI-IM resource indices (given by ltm-CSI-IM-ResourceList) e.g. corresponding to a list of Z CSI-IM resources for interference measurement(s) and a list of Z LTM-CandidateIds (given by ltm-CandidateIdList) referring to candidate cells associated with the CSI-IM resource indices. For CSI acquisition associated with a Reporting Setting, ltm-CSI-ReportConfig: in one example, the UE is expected to measure the CSI-IM resources in ltm-CSI-IM-ResourceList associated with the LTM-CandidateId that is equal to the LTM-CandidateId of the LTM-Candidate under which the Reporting Setting is configured; in another example, the UE is expected to measure all the CSI-IM resources in ltm-CSI-IM-ResourceList.

| | |
|---|---|
| LTM-CSI-IM-ResourceSet-r19 ::= | SEQUENCE { |
| ltm-CSI-IM-ResourceList-r19 | SEQUENCE (SIZE (1..maxNrofLTM-CSI-IM- |

ResourcesPerSet-R19)) OF CSI-IM-ResourceId,

| | |
|---|---|
| ltm-CandidateIdList-r19 | SEQUENCE (SIZE (1..maxNrofLTM-CSI- |

ResourcesPerSet-r18)) OF LTM-CandidateId-r18,
...
}
or

| | |
|---|---|
| LTM-CSI-IM-ResourceSet-r19 ::= | SEQUENCE { |
| ltm-CSI-IM-ResourceSetId-r19 | CSI-IM-ResourceSetId, |
| ltm-CandidateIdList-r19 | SEQUENCE (SIZE (1..maxNrofLTM-CSI- |

ResourcesPerSet-r18)) OF LTM-CandidateId-r18,
...
}
or

| | |
|---|---|
| LTM-CSI-IM-ResourceSet-r19 ::= | SEQUENCE { |
| ltm-CSI-IM-ResourceList-r19 | SEQUENCE (SIZE (1..maxNrofLTM-CSI-IM- |

ResourcesPerSet-R19)) OF CSI-IM-ResourceId,
...
}
or

| | |
|---|---|
| LTM-CSI-IM-ResourceSet-r19 ::= | SEQUENCE { |
| ltm-CSI-IM-ResourceList-r19 | SEQUENCE (SIZE (1..maxNrofLTM-CSI-IM- |

ResourcesPerSet-R19)) OF CSI-IM-ResourceId,
...
}

For another example (when/if two Resource Settings are configured according to or following those specified/defined herein in the present disclosure),
the first Resource Setting given by higher layer parameter ltm-ResourcesForChannelMeasurement, LTM-CSI-ResourceConfig, contains configuration of a ltm-NZP-CSI-RS-ResourceSet which comprises of a list of Z≥1 NZP CSI-RS resource indices (given by ltm-CSI-RS-ResourceList) e.g. corresponding to a list of Z NZP CSI-RS resources for channel measurement(s) and a list of Z LTM-CandidateIds (given by ltm-CandidateIdList) referring to candidate cells associated with the NZP CSI-RS resource indices. For CSI acquisition associated with a Reporting Setting, ltm-CSI-ReportConfig, the UE is expected to measure the NZP-CSI-RS resources in ltm-CSI-RS-ResourceList associated with the LTM-CandidateId that is equal to the LTM-CandidateId of the LTM-Candidate under which the Reporting Setting is configured;
the second Resource Setting given by higher layer parameter ltm-ResourcesForInterferenceMeasurement, LTM-CSI-ResourceConfig, contains configuration of a ltm-CSI-IM-ResourceSet which comprises of a list of Z≥1 CSI-IM resource indices (given by ltm-CSI-IM-ResourceList) e.g. corresponding to a list of Z CSI-IM resources for interference measurement(s); in this case, the CSI-IM resource indices could be (one-to-one) associated with/to the candidate cells in the aforementioned list of Z LTM-CandidateIds (given by ltm-CandidateIdList) comprised by/in the configuration of the ltm-NZP-CSI-RS-ResourceSet contained by/in the first Resource Setting given by higher layer parameter ltm-ResourcesForChannelMeasurement, LTM-CSI-ResourceConfig. For CSI acquisition associated with a Reporting Setting, ltm-CSI-ReportConfig: in one example, the UE is expected to measure the CSI-IM resources in ltm-CSI-IM-ResourceList associated with the LTM-CandidateId that is equal to the LTM-CandidateId of the LTM-Candidate under which the Reporting Setting is configured; in another example, the UE is expected to measure all the CSI-IM resources in ltm-CSI-IM-ResourceList.

| | |
|---|---|
| LTM-CSI-ResourceConfig-r18 ::= | SEQUENCE { |
| ltm-CSI-ResourceConfigId-r18 | LTM-CSI-ResourceConfigId-r18, |
| ltm-SSB-ResourceSet-r18 | LTM-SSB-ResourceSet-r18, |

...,

| | |
|---|---|
| ltm-NZP-CSI-RS-ResourceSet-r19 | LTM-NZP-CSI-RS-ResourceSet-19 |

OPTIONAL, -- Need R

| | |
|---|---|
| ltm-CSI-IM-ResourceSet-r19 | LTM-CSI-IM-ResourceSet-r19 |

OPTIONAL, -- Need R

| | |
|---|---|
| resourceType-r19 | ENUMERATED {periodic, semiPersistent} |

OPTIONAL -- Cond NoSSB

| | |
|---|---|
| ltm-CandidateIdList-r19 | SEQUENCE (SIZE (1..maxNrofLTM-CSI-ResourcesPerSet- |

r18)) OF LTM-CandidateId-r18,
}
or

| | |
|---|---|
| LTM-CSI-ResourceConfig-r18 ::= | SEQUENCE { |
| ltm-CSI-ResourceConfigId-r18 | LTM-CSI-ResourceConfigId-r18, |
| ltm-SSB-ResourceSet-r18 | LTM-SSB-ResourceSet-r18, |

...,

| | |
|---|---|
| ltm-NZP-CSI-RS-ResourceSet-r19 | LTM-NZP-CSI-RS-ResourceSet-r19 |

OPTIONAL, -- Need R

| | |
|---|---|
| ltm-CSI-IM-ResourceSet-r19 | LTM-CSI-IM-ResourceSet-r19 |

OPTIONAL, -- Need R

| | |
|---|---|
| resourceType-r19 | ENUMERATED {periodic, semiPersistent} |

OPTIONAL -- Cond NoSSB

| | |
|---|---|
| ltm-CandidateIdList-r19 | SEQUENCE (SIZE (1..maxNrofLTM-CSI-IM- |

ResourcesPerSet-r18)) OF LTM-CandidateId-r18,
...
}

For another example (when/if two Resource Settings are configured according to or following those specified/defined herein in the present disclosure), the higher layer parameter LTM-CSI-ResourceConfig could contain a list of Z≥1 LTM-CandidateIds (given by ltm-CandidateIdList) referring to candidate cells
the first Resource Setting given by higher layer parameter ltm-ResourcesForChannelMeasurement, LTM-CSI-ResourceConfig, contains configuration of a ltm-NZP-CSI-RS-ResourceSet which comprises of a list of Z≥1 NZP CSI-RS resource indices (given by ltm-CSI-RS-ResourceList) e.g. corresponding to a list of Z NZP CSI-RS resources for channel measurement(s), which could be associated with/to the candidate cells in the aforementioned list of Z≥1 LTM-CandidateIds (given by ltm-CandidateIdList) comprised by/in the higher layer parameter LTM-CSI-ResourceConfig. For CSI acquisition associated with a Reporting Setting, ltm-CSI-ReportConfig, the UE is expected to measure the NZP-CSI-RS resources in ltm-CSI-RS-ResourceList associated with the LTM-CandidateId that is equal to the LTM-CandidateId of the LTM-Candidate under which the Reporting Setting is configured;
the second Resource Setting given by higher layer parameter ltm-ResourcesForInterferenceMeasurement, LTM-CSI-ResourceConfig, contains configuration of a ltm-CSI-IM-ResourceSet which comprises of a list of Z≥1 CSI-IM resource indices (given by ltm-CSI-IM-ResourceList) e.g. corresponding to a list of Z CSI-IM resources for interference measurement(s), which could be associated with/to the candidate cells in the aforementioned list of Z≥1 LTM-CandidateIds (given by ltm-CandidateIdList) comprised by/in the higher layer parameter LTM-CSI-ResourceConfig. For CSI acquisition associated with a Reporting Setting, ltm-CSI-ReportConfig: in one example, the UE is expected to measure the CSI-IM resources in ltm-CSI-IM-ResourceList associated with the LTM-CandidateId that is equal to the LTM-CandidateId of the LTM-Candidate under which the Reporting Setting is configured; in another example, the UE is expected to measure all the CSI-IM resources in ltm-CSI-IM-ResourceList.

For another example:
when/if one Resource Setting is configured according to or following those specified/defined herein in the present disclosure, the Resource Setting given by higher layer parameter ltm-ResourcesForChannelMeasurement, LTM-CSI-ResourceConfig, could contain configuration(s) of one or more (e.g., Y≥1) NZP CSI-RS resource sets each provided/configured by/with a ltm-NZP-CSI-RS-ResourceSet comprising of a list of Z≥1 NZP CSI-RS resource indices (given by ltm-CSI-RS-ResourceList) e.g. corresponding to a list of Z NZP CSI-RS resources for both channel and interference measurements. For this example, the configuration of a NZP CSI-RS resource set or a ltm-NZP-CSI-RS-ResourceSet—e.g., one/each of the one or more (e.g., Y≥1) NZP CSI-RS resource sets or ltm-NZP-CSI-RS-ResourceSets—could comprise a LTM-CandidateId such that the candidate cell (or LTM-Candidate) of/having the LTM-CandidateId could be associated with/to the NZP CSI-RS resources (e.g., provided by ltm-CSI-RS-ResourceList) in the corresponding NZP CSI-RS resource set or the corresponding ltm-NZP-CSI-RS-ResourceSet. In this case, for CSI acquisition associated with a Reporting Setting, ltm-CSI-ReportConfig, the UE is expected to measure the NZP CSI-RS resources in ltm-CSI-RS-ResourceList in the corresponding NZP CSI-RS resource set or the corresponding ltm-NZP-CSI-RS-ResourceSet that is associated with the LTM-CandidateId that is equal to the LTM-CandidateId of the LTM-Candidate under which the Reporting Setting is configured;
when/if two Resource Settings are configured according to or following those specified/defined herein in the present disclosure, the first Resource Setting given by higher layer parameter ltm-ResourcesForChannelMeasurement, LTM-CSI-ResourceConfig, could contain configuration(s) of one or more (e.g., Y≥1) NZP CSI-RS resource sets each provided/configured by/with a ltm-NZP-CSI-RS-ResourceSet comprising of a list of Z≥1 NZP CSI-RS resource indices (given by ltm-CSI-RS-ResourceList) e.g. corresponding to a list of Z NZP CSI-RS resources for channel measurement(s). For this example, the configuration of a NZP CSI-RS resource set or a ltm-NZP-CSI-RS-ResourceSet—e.g., one/each of the one or more (e.g., Y≥1) NZP CSI-RS resource sets or ltm-NZP-CSI-RS-ResourceSets—could comprise a LTM-CandidateId such that the candidate cell (or LTM-Candidate) of/having the LTM-CandidateId could be associated with/to the NZP CSI-RS resources (e.g., provided by ltm-CSI-RS-ResourceList) in the corresponding NZP CSI-RS resource set or the corresponding ltm-NZP-CSI-RS-ResourceSet. In this case, for CSI acquisition associated with a Reporting Setting, ltm-CSI-ReportConfig, the UE is expected to measure the NZP CSI-RS resources in ltm-CSI-RS-ResourceList in the corresponding NZP CSI-RS resource set or the corresponding ltm-NZP-CSI-RS-ResourceSet that is associated with the LTM-CandidateId that is equal to the LTM-CandidateId of the LTM-Candidate under which the Reporting Setting is configured.

For another example (when/if two Resource Settings are configured according to or following those specified/defined herein in the present disclosure), the second Resource Setting given by higher layer parameter ltm-ResourcesForInterferenceMeasurement, LTM-CSI-ResourceConfig, could contain configuration(s) of one or more (e.g., Y≥1) CSI-IM resource sets each provided/configured by/with a ltm-CSI-IM-ResourceSet comprising of a list of Z≥1 CSI-IM resource indices (given by ltm-CSI-IM-ResourceList) e.g. corresponding to a list of Z CSI-IM resources for interference measurement(s). For this example, the configuration of a CSI-IM resource set or a ltm-CSI-IM-ResourceSet—e.g., one/each of the one or more (e.g., Y≥1) CSI-IM resource sets or ltm-CSI-IM-ResourceSets—could comprise a LTM-CandidateId such that the candidate cell (or LTM-Candidate) of/having the LTM-CandidateId could be associated with/to the CSI-IM resources (e.g., provided by ltm-CSI-IM-ResourceList) in the corresponding CSI-IM resource set or the corresponding ltm-CSI-IM-ResourceSet. In this case, for CSI acquisition associated with a Reporting Setting, ltm-CSI-ReportConfig: in one example, the UE is expected to measure the CSI-IM resources (e.g., provided by ltm-CSI-IM-ResourceList) in the corresponding CSI-IM resource set or the corresponding ltm-CSI-IM-ResourceSet that is associated with the LTM-CandidateId that is equal to the LTM-CandidateId of the LTM-Candidate under which the Reporting Setting is configured; in another example, the UE is expected to measure all the CSI-IM resources in all the one or more (e.g., Y≥1) CSI-IM resource sets/ltm-CSI-IM-ResourceSets.

The UE shall expect the following configuration provided by ltm-CSI-ReportConfig:
For the frequency granularity of the CSI report, the CQI format indicator is Wideband CQI.
For the frequency granularity of the CSI report, the PMI format indicator is Wideband PMI.
The codebook type is typeI-SinglePanel.
The reportQuantity is set to ‘cri-RI-PMI-CQI’.

After a UE receives an LTM Cell Switch Command MAC CE [10, REF 5] providing a candidate cell (given by Target Configuration ID field), and a ltm-CSI-ReportConfig is configured for the candidate cell, the UE can measure corresponding NZP CSI-RS resources and CSI-IM resources if configured, and shall transmit a CSI report to the candidate cell.

For RACH-less LTM cell switch [23, 3GPP TS 38.300], the UE shall transmit the CSI report to the candidate cell using the first PUSCH corresponding to a dynamic grant or a configured grant [6, REF 3].

For RACH-based LTM cell switch using a contention-free random access procedure [23, 3GPP TS 38.300], the UE shall transmit the CSI report to the candidate cell using the PUSCH scheduled by the RAR UL grant or MsgA PUSCH.

For RACH-based LTM cell switch using a contention-based random access procedure [23, 3GPP TS 38.300], the UE shall transmit the CSI report to the candidate cell using the first PUSCH corresponding to a dynamic grant or a configured grant after the HARQ-ACK transmission corresponding to Msg4 or MsgB.

If a valid CSI is not available, the UE shall transmit a CSI report which contains a CQI corresponding to the lowest CQI index. Depending on the UE capability, the UE may measure NZP CSI-RS resources and CSI-IM resources if configured corresponding to a ltm-CSI-ReportConfig before receiving the LTM Cell Switch Command MAC CE [10, REF 5].

For RACH-based LTM cell switch [19, 3GPP TS 38.300], the UE applies the CandidateTCI-State for receptions on the candidate cell, and applies a spatial domain filter corresponding to the CandidateTCI-State or the CandidateTCI-UL-State for transmissions on the candidate cell, that are after the completion of the random access procedure associated with the PRACH transmission on the candidate cell and before a new TCI state is applied for the candidate cell. For RACH-less LTM cell switch [19, 3GPP TS 38.300], the UE applies the CandidateTCI-State for receptions on the candidate cell and applies a spatial domain filter corresponding to the CandidateTCI-State or the CandidateTCI-UL-State for transmissions on the candidate cell before a new TCI state is applied for the candidate cell.

After RACH-based conditional LTM cell switch, all activated TCI states are deactivated. For RACH-less conditional LTM cell switch, the UE determines a TCI state in CandidateTCI-State or CandidateTCI-UL-State to apply for receptions or transmissions on the candidate cell, where:
when the QCL RS of the TCI state is a CSI-RS resource, the QCL RS is same as the CSI-RS resource selected in the RACH-less conditional LTM cell switch as described in clause 5.36.3 [11, REF 5], or QCLed with the SS/PBCH block selected in the RACH-less conditional LTM cell switch as described in clause 5.36.3 [11, REF 5]; and/or
when the QCL RS of the TCI state is a SS/PBCH block, the QCL RS is same as the SS/PBCH block selected in the RACH-less conditional LTM cell switch as described in clause 5.36.3 [11, REF 5].

Or equivalently, the QCL RS of the TCI state is same as the SS/PBCH block or the CSI-RS resource selected in the RACH-less conditional LTM cell switch as described in clause 5.36.3 [11, REF 5]; when applicable, e.g., when/if the QCL RS of the TCI state is a CSI-RS and/or a SS/PBCH block is selected in the RACH-less conditional LTM cell switch as described in clause 5.36.3 [11, REF 5], the QCL RS is QCLed with the SS/PBCH block selected in the RACH-less conditional LTM cell switch as described in clause 5.36.3 [11, REF 5]. After RACH-less conditional LTM cell switch, all activated TCI states, other than the TCI state, are deactivated.

Throughout the present disclosure, a UE could determine or identify value(s) of T_delay and/or T_proc according to or based on or following one or more of: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, throughout the present disclosure, a MAC CE including e.g. a candidate cell TCI states activation/deactivation MAC CE, an LTM Cell Switch Command MAC CE, an SP CSI-RS/CSI-IM resource(s)/resource set(s) activation/deactivation MAC CE and/or etc. is applied or becomes applicable T_{HARQ}+3 ms after receiving/reception of (e.g., after the end or the last symbol/slot/etc. of) the MAC CE, wherein T_{HARQ} is the time between the last TTI containing the MAC CE and ACK for the PDSCH that provides the MAC CE. Or the slot when the MAC CE is applied or becomes applicable could correspond to the first slot that is after

$$slot n + 3 {N}_{slot}^{subframe , μ}$$

when the UE would transmit a PUCCH with HARQ-ACK information in slot n corresponding to the PDSCH carrying the MAC CE where μ is the SCS configuration for the PUSCH(s), and

$${N}_{slot}^{subframe , μ}$$

is the number of slots in a frame. And, the LTM beam application time (i.e., when a/the TCI state indicated in/by the LTM Cell Switch Command MAC CE for the candidate cell for cell switch is applied or becomes applicable) could be no later than T_{LTM-RRC-processing}+T_{LTM-processing}+T_{first-RS}+T_{RS-proc}+3 ms after the last symbol of a PUCCH or PUSCH with HARQ-ACK information for the PDSCH providing the LTM CSC MAC CE, where T_{LTM-RRC-processing}, T_{LTM-processing}, T_{first-RS}, and T_{RS-proc} are defined in the 3GPP TS 38.133.

The examples/procedures specified or described throughout the present disclosure for CSI acquisition (including CSI-RS(s) measurement(s) and/or CSI reporting) based on or according to LTM CSC MAC CE could be equally applied or extended to CSI acquisition (including CSI-RS(s) measurement(s) and/or CSI reporting) based on or according to Msg2 RAR (e.g., for RACH-based LTM operation(s)). Furthermore, throughout the present disclosure, a CSI-RS resource set or a SSB resource set could be referred to as a CSI resource set, which could be provided or configured in higher layer parameter(s)/signaling(s) LTM-Config, LTM-Candidate, LTM-CSI-ReportConfig, LTM-CSI-ResourceConfig, LTM-TCI-Info and/or etc. and associated, specific, corresponding or linked to a candidate cell/candidate cell ID.

Throughout the present disclosure, a candidate cell/candidate cell ID from/in the list/set/pool of all configured candidate cells/candidate cell IDs could be configured with higher layer parameter EarlyUlSyncConfig. Furthermore, a candidate cell/candidate cell ID in a/the subset of candidate cell(s)/candidate cell ID(s) for CSI acquisition in LTM operation(s) as specified/defined herein in the present disclosure could be configured with higher layer parameter EarlyUlSyncConfig.

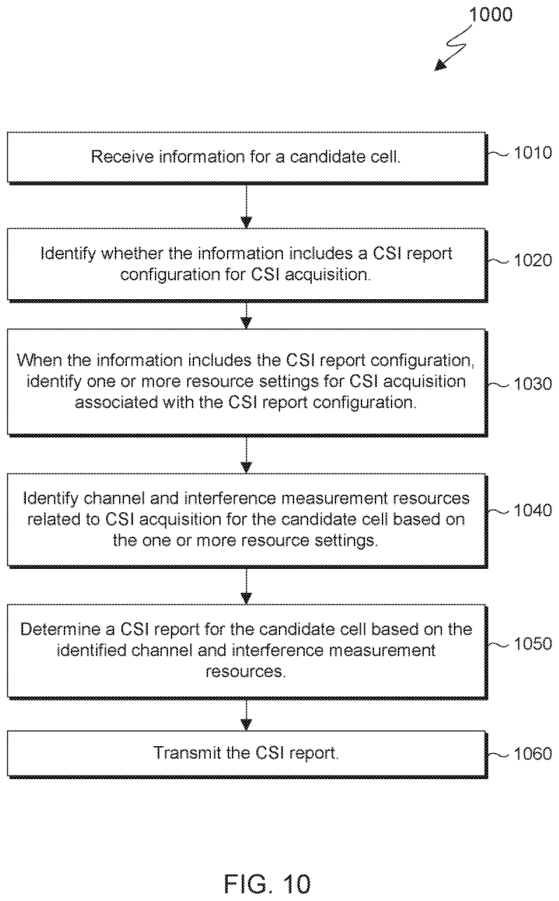

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

The method begins with the UE receiving information for a candidate cell (1010). In various embodiments, the information includes the CSI report configuration for CSI acquisition and is provided in a RRC message. The UE then identifies whether the information includes a CSI report configuration for CSI acquisition (1020).

The UE then, when the information includes the CSI report configuration, identifies one or more resource settings for CSI acquisition associated with the CSI report configuration (1030). The UE then identifies channel and interference measurement resources related to CSI acquisition for the candidate cell based on the one or more resource settings (1040). In various embodiments, when one resource setting from the one or more resource settings is identified, the one resource setting provides a set of one or more NZP CSI-RS resources and the set of the one or more NZP CSI-RS resources are for channel and interference measurements. In various embodiments, the one or more NZP CSI-RS resources are associated with one or more candidate cells, and the one resource setting provides information related to the one or more candidate cells including IDs or indexes of the one or more candidate cells. In various embodiments, when first and second resource settings, from the one or more resource settings, are identified the first resource setting provides a set of one or more NZP CSI-RS resources for channel measurements and the second resource setting provides a set of one or more CSI-IM resources for interference measurements. In various embodiments, the one or more NZP CSI-RS resources in the set are associated with one or more first candidate cells. The one or more CSI-IM resources in the set are associated with one or more second candidate cells.

The UE then determines a CSI report for the candidate cell based on the identified channel and interference measurement resources (1050). The UE then transmits the CSI report (1060). In various embodiments, the first resource setting provides information related to the one or more first candidate cells including IDs or indexes of the one or more first candidate cells. The second resource setting provides information related to the one or more second candidate cells including IDs or indexes of the one or more second candidate cells. The CSI report for the candidate cell is determined based on the one or more NZP CSI-RS resources and the one or more CSI-IM resources associated with the candidate cell.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive information for a candidate cell; and
a processor operably coupled with the transceiver, the processor configured to:
identify whether the information includes a channel state information (CSI) report configuration for CSI acquisition;
identify, when the information includes the CSI report configuration, one or more resource settings for CSI acquisition associated with the CSI report configuration;
identify, based on the one or more resource settings, channel and interference measurement resources related to CSI acquisition for the candidate cell; and
determine a CSI report for the candidate cell based on the identified channel and interference measurement resources,
wherein the transceiver is further configured to transmit the CSI report.

2. The UE of claim 1, wherein the information:
includes the CSI report configuration for CSI acquisition, and
is provided in a radio resource control (RRC) message.

3. The UE of claim 1, wherein:
when one resource setting from the one or more resource settings is identified, the one resource setting provides a set of one or more non-zero-power (NZP) CSI reference signal (CSI-RS) resources, and
the set of the one or more NZP CSI-RS resources are for channel and interference measurements.

4. The UE of claim 3, wherein:
the one or more NZP CSI-RS resources are associated with one or more candidate cells, and
the one resource setting provides information related to the one or more candidate cells including identifiers (IDs) or indexes of the one or more candidate cells.

5. The UE of claim 1, wherein, when first and second resource settings, from the one or more resource settings, are identified:
the first resource setting provides a set of one or more non-zero-power (NZP) CSI reference signal (CSI-RS) resources for channel measurements, and
the second resource setting provides a set of one or more CSI interference measurement (CSI-IM) resources for interference measurements.

6. The UE of claim 5, wherein:
the one or more NZP CSI-RS resources in the set are associated with one or more first candidate cells, and
the one or more CSI-IM resources in the set are associated with one or more second candidate cells.

7. The UE of claim 6, wherein:
the first resource setting provides information related to the one or more first candidate cells including identifiers (IDs) or indexes of the one or more first candidate cells,
the second resource setting provides information related to the one or more second candidate cells including IDs or indexes of the one or more second candidate cells, and
the CSI report for the candidate cell is determined based on the one or more NZP CSI-RS resources and the one or more CSI-IM resources associated with the candidate cell.

8. A base station (BS), comprising:
a processor; and
a transceiver operably coupled with the processor, the transceiver configured to:
transmit information for a candidate cell, wherein the information includes a channel state information (CSI) report configuration for CSI acquisition, wherein the information indicates one or more resource settings for CSI acquisition associated with the CSI report configuration, wherein the one or more resource settings indicate channel and interference measurement resources related to CSI acquisition for the candidate cell; and
receive a CSI report for the candidate cell, the CSI report based on the channel and interference measurement resources.

9. The BS of claim 8, wherein the information:
includes the CSI report configuration for CSI acquisition, and
is provided in a radio resource control (RRC) message.

10. The BS of claim 8, wherein:
when one resource setting from the one or more resource settings is indicated, the one resource setting provides a set of one or more non-zero-power (NZP) CSI reference signal (CSI-RS) resources, and
the set of the one or more NZP CSI-RS resources are for channel and interference measurements.

11. The BS of claim 10, wherein:
the one or more NZP CSI-RS resources are associated with one or more candidate cells, and
the one resource setting provides information related to the one or more candidate cells including identifiers (IDs) or indexes of the one or more candidate cells.

12. The BS of claim 8, wherein, when first and second resource settings, from the one or more resource settings, are indicated:
the first resource setting provides a set of one or more non-zero-power (NZP) CSI reference signal (CSI-RS) resources for channel measurements, and
the second resource setting provides a set of one or more CSI interference measurement (CSI-IM) resources for interference measurements.

13. The BS of claim 12, wherein:
the one or more NZP CSI-RS resources in the set are associated with one or more first candidate cells, and
the one or more CSI-IM resources in the set are associated with one or more second candidate cells.

14. The BS of claim 13, wherein:
the first resource setting provides information related to the one or more first candidate cells including identifiers (IDs) or indexes of the one or more first candidate cells,
the second resource setting provides information related to the one or more second candidate cells including IDs or indexes of the one or more second candidate cells, and
the CSI report for the candidate cell is determined based on the one or more NZP CSI-RS resources and the one or more CSI-IM resources associated with the candidate cell.

15. A method performed by a user equipment (UE), the method comprising:
receiving information for a candidate cell;
identifying whether the information includes a channel state information (CSI) report configuration for CSI acquisition;
identifying, when the information includes the CSI report configuration, one or more resource settings for CSI acquisition associated with the CSI report configuration;
identifying, based on the one or more resource settings, channel and interference measurement resources related to CSI acquisition for the candidate cell;
determining a CSI report for the candidate cell based on the identified channel and interference measurement resources; and
transmitting the CSI report.

16. The method of claim 15, wherein the information:
includes the CSI report configuration for CSI acquisition, and
is provided in a radio resource control (RRC) message.

17. The method of claim 15, wherein:
when one resource setting from the one or more resource settings is identified, the one resource setting provides a set of one or more non-zero-power (NZP) CSI reference signal (CSI-RS) resources, and
the set of the one or more NZP CSI-RS resources are for channel and interference measurements.

18. The method of claim 17, wherein:
the one or more NZP CSI-RS resources are associated with one or more candidate cells, and
the one resource setting provides information related to the one or more candidate cells including identifiers (IDs) or indexes of the one or more candidate cells.

19. The method of claim 15, wherein, when first and second resource settings, from the one or more resource settings, are identified:
the first resource setting provides a set of one or more non-zero-power (NZP) CSI reference signal (CSI-RS) resources for channel measurements, and
the second resource setting provides a set of one or more CSI interference measurement (CSI-IM) resources for interference measurements.

20. The method of claim 19, wherein:
the one or more NZP CSI-RS resources in the set are associated with one or more first candidate cells, and
the one or more CSI-IM resources in the set are associated with one or more second candidate cells.
